(19) United States
(12) Patent Application Publication
(10) Pub. No.: US 2024/0081368 A1
(43) Pub. Date: Mar. 14, 2024

(54) MODIFIED PLANT PROTEINS WITH ENHANCED FUNCTIONAL PROPERTIES FOR FOOD USES

(71) Applicant: Kansas State University Research Foundation, Manhattan, KS (US)

(72) Inventors: Yonghui LI, Manhattan, KS (US); Yanting SHEN, Manhattan, KS (US)

(21) Appl. No.: 18/262,961

(22) PCT Filed: Jan. 28, 2022
(86) PCT No.: PCT/US2022/014188

§ 371 Date: Jul. 26, 2023

Related U.S. Application Data
(60) Provisional application No. 63/143,322, filed on Jan. 29, 2021.
(60) Provisional application No. 63/246,372, filed on Sep. 21, 2021.
(60) Provisional application No. 63/286,884, filed on Dec. 7, 2021.

(51) Int. Cl. A23J 3/14; A23L 29/00; A23L 29/10

(52) U.S. Cl. CPC A23J 3/14; A23L 29/03; A23L 29/10

(57) ABSTRACT

Improved methods for preparing functional food ingredients comprising plant protein, the resulting enhanced functional food ingredients, and foods containing the same. The methods comprise providing a mixture or slurry of plant protein in an aqueous solution, reacting the plant protein with a modification agent selected from the group consisting of an acylating agent, transglutaminase, and protein glutaminase to yield a modified plant protein, and conjugating the modified plant protein with a hydrophilic polysaccharide to yield the functional food ingredient with synergistic improvements in properties.

### CROSS-REFERENCE TO RELATED APPLICATIONS

The present application claims the priority benefit of U.S. Provisional Patent Application Ser. No. 63/286,884, filed Dec. 7, 2021, Ser. No. 63/246,372, filed Sep. 21, 2021, and Ser. No. 63/143,322, filed Jan. 29, 2021, each entitled MODIFIED PLANT PROTEINS WITH ENHANCED FUNCTIONAL PROPERTIES FOR FOOD USES, and each incorporated by reference in its entirety herein.

### STATEMENT REGARDING FEDERALLY-FUNDED RESEARCH

This invention was made with U.S. Government support under 58-3060-0-046 awarded by the United States Department of Agriculture. The government has certain rights in the invention.

### BACKGROUND

### Field

The present disclosure relates to novel modified plant proteins and their use as functional food ingredients.

### Description of Related Art

Plant materials are an economic source of a number widely utilized functional food ingredients, including protein extenders, fillers, emulsifiers, taste and texture enhancers, and the like. Plant proteins are used as ingredients in foods to achieve functional and nutritional properties. There has been an increasing demand for diverse and more functional plant-based protein ingredients for food uses. This requires that these plant-based protein ingredients have not only satisfactory nutritional properties, but also acceptable taste and texture profiles and contribute favorable characteristics to the final food product. However, the use of plant proteins in food products is still very limited. Unmodified plant proteins normally present limitations in functional properties or applicability in processed food systems. There remains a need for improved functional foods derived from plant proteins.

### SUMMARY

Described herein are plant-based functional food ingredients having improved properties. As used herein reference to a “functional food” ingredient means that, in addition to its nutritional properties, the ingredient contributes a non-nutritional property to the food into which it is added, and in particular contributes towards obtaining the desired final characteristics of the food (e.g., flavor, texture, color, moisture, workability, etc.). Thus, in the case of plant-derived proteins, the modified functional food ingredients described herein contribute an additional favorable characteristic to the food, beyond adding protein and/or fiber content. Methods for modifying plant proteins are also described herein to greatly improve the functional properties (e.g., emulsion, gelatin, water holding, oil holding, foaming, solubility) of plant proteins. This technology is applicable to pea protein, soy protein, chickpea protein, and protein isolates or hydrolysates of the same, as demonstrated in the working examples, but is also applicable to other plant proteins, including, without limitation, plant proteins and isolates from starchy cereals (e.g., wheat, maize, oats, rye, barley, triticale, rice, sorghum, etc.), starchy legumes (e.g., field peas and chickpeas demonstrated herein, as well as fababeans, navy beans, pinto beans, mung bean, lupin, etc.) oilseeds (e.g., soy demonstrated herein, as well as sunflower seed, rapeseed, hempseed, peanuts, etc.), starchy pseudocereals (e.g., buckwheat, quinoa, amaranth, chia, etc.) and the like. It will be appreciated that the extent of functional enhancement may vary depending on the types of plant proteins and their respective protein composition, amino acid composition and sequence, and molecular size, etc.

In one or more embodiments, processes are described herein to improve the functional properties of plant proteins through acylation or/and conjugation with polysaccharides (e.g., guar gum, pectin, gum arabic, or soy polysaccharide). In one or more embodiments, processes are described herein to improve the functional properties of plant proteins through enzymatic modification using protein glutaminase and subsequent conjugation with polysaccharides. Enzymatic modification and/or conjugation with polysaccharides altered pea protein secondary structure compositions, molecular sizes, surface hydrophobicity, and contents of free sulfhydryl and amino groups, thus resulting in different functional characteristics. Thus, also described herein are new modified plant proteins and various applications for their use as functional food ingredients.

These modifications demonstrated synergistic effects and showed dramatic improvement of protein functional properties compared to the unmodified protein or protein modified with only a single approach.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Figure (FIG.) 1 is a graph of the solubility of pea and modified pea proteins in Example 1.

FIG. 2 is a graph of the foaming capacity and stability of pea and modified pea proteins in Example 1.

FIG. 3 is a graph of the browning reaction in modified pea proteins in Example 1. *Means with different lowercase or capital letters denote significant differences (p<0.05).

FIG. 4 is a graph of the Free amino group content of pea and modified pea proteins in Example 1. *Means with different letters denote significant differences (p<0.05).

FIG. 5 is a graph of the FTIR spectra of pea protein and selected modified pea proteins in Example 1.

FIG. 6 is a photograph of the electrophoretic patterns of pea and modified pea proteins under reducing conditions in Example 1: Lane M-molecular weight marker; Lane 1: pea; Lane 2: 1:20 guar gum mix; Lane 3: 1:40 guar gum mix; Lane 4: 1:20 guar gum conjugate; Lane 5: 1:40 guar gum conjugate; Lane 6: AA 0.3; Lane 7: AA 0.6; Lane 8: SA 0.3; Lane 9: SA 0.6; Lane 10: AA 0.3 conjugate; Lane 11: AA 0.6 conjugate; Lane 12: SA 0.3 conjugate; Lane 13: SA 0.6 conjugate.

FIG. 7 is a graph of the in vitro digestibility in terms of degree of hydrolysis (DH) of pea and modified pea proteins in Example 1. *Means with different letters denote significant differences (p<0.05).

FIG. 8 shows photos of protein powders (PPI and PGG) used in Example 2.

FIG. 9 shows photos of raw beef patties extended with PPI or PGG in Example 2.

FIG. 10 is a visual graph of the descriptive sensory scores of different beef patties in Example 2.

FIG. 11 is a Principal component analysis (PCA) biplot describing the relationships between physical texture parameters and sensory attributes of different beef patties in Example 2.

FIG. 12 is an image of the Trained sensory panel ballot for beef patty evaluation in Example 2.

FIG. 13 shows the SEC-HPLC chromatograms of the control and modified pea proteins in Example 3.

FIG. 14 is a graph of the solubility of pea and modified pea proteins in Example 3.

FIG. 15 is a graph of the in vitro gastrointestinal digestibility (DH %) of pea and modified pea proteins in Example 3. *Means with different letters indicate significant differences (p<0.05).

FIG. 16 shows photographs of emulsions after stability tests (i.e., heating and centrifugation treatment) at different pH, NaCl concentrations, protein concentrations, and oil/water with PPI or G-PPI, in Example 4.

FIG. 17A shows a graph of the apparent viscosity of emulsions at different pH, NaCl concentrations, protein concentrations, and oil/water ratios containing pea protein isolate (PPI) at different Ph.

FIG. 17B shows a graph of the apparent viscosity of emulsions at different pH, NaCl concentrations, protein concentrations, and oil/water ratios containing modified pea protein (G-PPI) at different pH.

FIG. 17C shows a graph of the apparent viscosity of emulsions at different pH, NaCl concentrations, protein concentrations, and oil/water ratios containing modified pea protein (G-PPI) at different protein concentrations.

FIG. 17D shows a graph of the apparent viscosity of emulsions at different pH, NaCl concentrations, protein concentrations, and oil/water ratios containing modified pea protein (G-PPI) at different NaCl concentrations.

FIG. 17E shows a graph of the apparent viscosity of emulsions at different pH, NaCl concentrations, protein concentrations, and oil/water ratios containing modified pea protein (G-PPI) at different oil/water ratios.

FIG. 18A is a graph of the viscoelastic properties (G′ and G″) of mayonnaise samples in Example 4 showing the frequency sweep of PPI mayonnaise.

FIG. 18B is a graph of the viscoelastic properties (G′ and G″) of mayonnaise samples in Example 4 showing the frequency sweep of G-PPI mayonnaise.

FIG. 18C is a graph of the viscoelastic properties (G′ and G″) of mayonnaise samples in Example 4 showing the frequency sweep of egg yolk mayonnaise.

FIG. 18D is a graph of the viscoelastic properties (G′ and G″) of mayonnaise samples in Example 4 showing the temperature sweep.

FIG. 18E shows photographs of mayonnaise samples made from pea protein isolate (PPI) (8%), egg yolk (10%), and the modified pea protein (G-PPI) (8%).

FIG. 19 is a graph of the Zeta potential of pea protein isolate (PPI) and the modified pea protein (G-PPI) at different pH conditions in Example 4.

FIG. 20A shows microscopy photographs of microstructures of oil-in-water emulsions with pea protein isolate (PPI) (1.5%) and the modified pea protein (G-PPI) (1.5%).

FIG. 20B shows microscopy photographs of microstructures of mayonnaises made from pea protein isolate (PPI), egg yolk, and the modified pea protein (G-PPI) at different concentrations in Example 4.

FIG. 21 shows photographs of mayonnaise samples with different plant protein or egg yolk concentrations after stability tests (i.e., heating and centrifugation treatment) in Example 4.

### DETAILED DESCRIPTION

In one aspect, provided herein are improved modified plant proteins for use as functional food ingredients. The resulting modified protein has broader food applications as functional ingredients than current plant-based proteins. Moreover, functional properties of plant proteins can be tailored through this technology according to specific industry needs (e.g., better emulsion, or better gelation, or better water holding, or better oil holding, etc.).

In one or more embodiments, the improved process can start with suitable proteinaceous plant material, which can be ground into powder (flour) to facilitate protein extraction. Alternatively, the process can start with proteinaceous plant powder, which can be subjected to a protein extraction process. Any suitable process can be used for obtaining a protein extract that is well known to those skilled in the art, such as solvent extraction, isoelectric precipitation or impregnation followed by a separation technique via screening, filtration, centrifugation or any other equivalent technique. The plant protein extract or isolate is then collected, and dried (e.g., lyophilized).

In one or more embodiments, the improved process can also start with pre-prepared plant protein meal, concentrate, isolate or hydrolysate, that has already been prepared or is commercially available. For example, suitable plant protein starting ingredients include protein ingredients with different protein levels, such as meal (˜50-60% protein), protein concentrate (˜65-80% protein), protein isolate (˜85-95% protein), and protein hydrolysate.

For preparing the modified proteins, the dried protein or extract can be first suspended in an aqueous slurry, and reacted with either a chemical or enzymatic modification agent for functionalization and/or crosslinking. In particular, the plant protein is reacted with an acylating agent (e.g., acetic anhydride (AA) or succinic anhydride (SA)), transglutaminase or protein glutaminase to yield a modified plant protein. Preferably, the plant protein extract is mixed with a chemical or enzymatic modification agent for a time period of from about 1 hour to about 24 hours, preferably about 1 hour to about 5 hours, at a temperature of from about 20 to about 70° C., and a pH of about 5 to about 10 (preferably about 8). The resulting modified plant protein can be washed with an aqueous wash solution (e.g., distilled water) to remove any residual unreacted modification agent. In one or more embodiments, the resulting modified plant protein is distilled with water for up to 48 hours to remove any residual unreacted modification agent.

Depending upon the modification technique, the resulting modified protein can be acylated, deamidated by protein glutaminase, or crosslinked by transglutaminase. The modified protein is then reacted with (conjugated to) the selected soluble polysaccharide. Preferably, the modified plant protein is mixed with a soluble polysaccharide in an aqueous solution for a time period of from about 1 hour to about 24 hours, at a temperature of from about 20 to about 70° C., and a pH of about 5 to about 10 (preferably about 8). In one aspect, the solution is mixed for less than 1 hour at room temperature (preferably about 10-30 min.) to ensure homogenous mixing, followed by incubating at an elevated temperature up to about 70° C. (preferably 50-70° C.) with continuous mixing for about 24 hours.

Suitable polysaccharide are preferably hydrophilic polysaccharides, such as guar gum, pectin, gum arabic, soybean soluble polysaccharide, xanthan, sodium alginate, propylene glycol alginate, carrageenan, chitosan, tara gum, carboxymethylcellulose, methylcellulose, hydroxypropylmethylcellulose, gellan gum, locust bean gum, and/or tragacanth gum. The resulting reaction solution is then dried into a powder.

Drying techniques include any techniques including spray drying, drum drying, or lyophilization. Preferably, the drying technique also evaporates excess water or otherwise dehydrates the resulting modified plant protein into a dried powder for storage and/or subsequent use.

Synergistic improvements in functional properties are seen by subjecting the protein to the two different sequential modification processes. It will be appreciated that the desired functional properties can be modulating by adjusting the particular chemical/enzymatic modification as well as the particular polysaccharide used for conjugation.

In one aspect, provided herein is a sequential acylation/conjugation method that greatly improves the water holding capacity, oil holding capacity, gelation, solubility, emulsion capacity and/or stability of plant proteins. In one or more embodiments, instead of conjugation, the acylated, deamidated, or crosslinked protein can simply be physically mixed with a selected polysaccharide in lieu of chemical conjugation, while still achieving functional benefits. In one or more embodiments, the method comprises mixing the modified protein with the polysaccharide in dry powder or aqueous slurry for less than 1 hour, preferably less than 30 minutes, more preferably for less than 5 minutes simple to homogenously mix the modified protein and polysaccharide (without reaction), at room temperature (about 20° C.-25° C.).

In one aspect, acylated plant proteins are prepared by reacting with acetic anhydride (AA) or succinic anhydride (SA), followed by conjugation to a hydrophilic polysaccharide, such that the modified protein, covalently linked with hydrophilic polysaccharide, has significantly improved protein solubility and emulsifying properties as compared to the unmodified protein. For example, both conjugated and acylated pea proteins showed significantly improved oil holding capacity of up to 2.2 and 2.1 g oil/g protein, respectively, compared to the unmodified protein (1.0 g oil/g). Acylated pea protein also had greater water holding capacity of up to 7.0 g water /g protein compared to the unmodified protein (3.6 g water/g). Emulsion capacity and stability were improved up to 96-100% and 95-100%, respectively, for the modified proteins (e.g., 1:20 conj., SA0.3/0.6, AA 0.3/0.6 conj., SA 0.3/0.6 conj.). Sequential acylation and conjugation of pea proteins demonstrated more beneficial and synergistic effects on the water holding capacity and emulsifying properties. Overall, the acylated (acetylated or succinylated) and conjugated pea proteins possessed superior functional properties that could be used as novel food ingredients in meat alternative or beverage applications. The technology was also leveraged to create modified soy protein and chickpea protein using the same approach and demonstrating the same improvements in functionality.

In one aspect, provided herein is a clean-label sequential enzymatic modification/conjugation method that greatly improves the functional properties of plant proteins. Modifications include either enzymatic deamidation of the protein using protein glutaminase or crosslinking of the protein using transglutaminase, followed by protein-polysaccharide conjugation. The modified/conjugated protein demonstrates improved emulsifying, foaming properties, solubility, and thermal stability.

In one aspect, modified plant proteins are prepared through sequential deamidation and conjugation that greatly improves water/oil holding capacity, emulsification and gelling properties, and solubility of plant proteins. In one aspect, modified plant proteins are prepared by sequential deamidation with protein glutaminase and conjugation with guar gum. In one aspect, glutamine residues are converted to glutamate residues, resulting in improved functional properties of the resulting product. In one aspect, modified plant proteins are prepared by crosslinking with transglutaminase.

Enzymatically modified plant proteins are prepared by reacting the protein with transglutaminase or protein-glutaminase. At the end of the reaction, the protein slurry is heated to inactivate the enzyme. The conjugated protein is prepared by dispersing the modified protein in a water slurry and mixing with the selected polysaccharide for a sufficient period of time. The resulting modified proteins have multiple functional enhancements as compared to the unmodified protein, including any one or more of solubility, water holding capacity, oil holding capacity, emulsion capacity, emulsion stability, gelation, foaming capacity, and the like. In addition, these modified proteins also maintain acceptable sensory characteristics when used in food products.

In one or more embodiments, modified plant proteins for use as functional food ingredients comprise acylated plant protein, deamidated plant protein, or transglutaminase crosslinked plant protein, further conjugated with a polysaccharide. In one or more embodiments, the modified proteins have a solubility in water of greater than 40%, preferably 50% or greater at pH 5 or above. In one or more embodiments, the modified proteins have a significantly higher OHC (increase by at least about 40%, preferably about 50%, more preferably at least about 60%) as compared to the unmodified protein. In one or more embodiments, the modified proteins have significantly higher emulsion capacity (EC) (increase by at least about 40%, preferably about 50%, more preferably at least about 60%) as compared to the unmodified protein. In one or more embodiments, the modified proteins have significantly higher emulsion stability (ES) (increase by at least about 40%, preferably about 50%, more preferably at least about 60%) as compared to the unmodified protein. In one or more embodiments, the modified proteins have significantly enhanced gelation properties as compared to the unmodified protein (i.e., meaning that the least gelation concentration decreases by at least about 30%). In one or more embodiments, the modified proteins are characterized by a protein secondary structure that is modified as compared to the unmodified protein.

The modified plant proteins can be used in a variety of applications, including as fillers or protein extenders in meat products, such as in ground and minced meat patties, sausages, emulsified meat products, hot dogs, artificial meat products, meat analogs, meat alternatives (e.g., soy based products) and the like. The improved water holding capacity of the modified protein can be used to retain moisture and juices released by cooking meat to improve water retention of the meat in the cooking process. The modified plant proteins can be also be used as emulsifiers, stabilizers, and/or thickening agents that can provide a creamy viscosity to the food product, such as in mayonnaise, gravies, yogurts, meal replacement beverages, soft drinks, dairy analogs, dairy or milk alternatives, butter, margarine, creamer, salad dressings, soups, sauces, desserts, ice creams, and the like. The modified plant proteins can be used to replace egg yolk or dairy protein. The modified plant proteins can be used as an alternative protein in dressings or alternative dairy applications to deliver the needed textural properties of such products without animal-based ingredients. Although exemplified for human food consumption, the modified plant proteins can also be used in pet food, such as dry foods, canned foods, semi-moist foods, and fresh pet foods, animal foods or feed, or as feed additives or top dressings.

Additional advantages of the various embodiments of the invention will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments, but is not necessarily included. Thus, the present invention encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### EXAMPLES

The following examples set forth methods in accordance with the invention. It is to be understood, however, that these examples are provided by way of illustration and nothing therein should be taken as a limitation upon the overall scope of the invention.

### Example 1

### 1. Introduction

There has been an increasing demand for plant-based proteins worldwide. Pea (Pisum sativum L.) is one of the most widely cultivated pulse legumes in the world, and it has been utilized in human's diet for thousands of years. Pea protein has significant nutritional advantages such as providing essential amino acids and being associated with health benefits such as reduction of LDL (low density lipoprotein) cholesterol, anti-inflammatory activity, modulating intestinal bacterial activities. Pea protein has been used to produce bioactive peptides with both antioxidant activity and angiotensin I-converting enzyme inhibitor activity. Additionally, pea protein hydrolysates showed beneficial effects on lowering blood pressure. Pea protein has gained great attention in the food and beverages industries as a potentially alterative protein to animal protein for human foods.

Pea contains 20-30% protein, and pea protein contains many essential amino acids, especially that it is rich in lysine, which accounts for approximately 6- 7.5% of the total amino acids. Legumin (11S protein) and vicilin (7S protein) are the two major globulin proteins in pea. So far, the utilization of pea protein as a food ingredient is still very limited, partially due to their less-desirable functionalities. For example, pea protein contains high percentage of globulin fraction (49-81%) (salt soluble protein), which showed low solubility in aqueous food system. Commercial pea protein is commonly subjected to harsh processing conditions, which may lead to protein denaturation and further reduce protein solubility. Other functionalities that are associated with solubility may also be impaired, such as water holding capacity, foaming capacity/stability, and emulsifying capacity/stability.

To overcome these limitations, previous studies have been conducted to improve pea protein functional properties through chemical modifications. Conjugation between protein and polysaccharide is a popular modification approach, which builds chemical linkages between the protein and polysaccharide via the condensation of carbonyl and 6-amino group at the initial stage of Maillard reaction. The conjugation reaction enables the protein to be covalently linked with hydrophilic polysaccharide, which enhances protein solubility and emulsifying properties. Pea protein conjugated with gum Arabic showed improved solubility as well as emulsifying properties. Additionally, the conjugation reaction mitigated the beany flavor of pea protein. Other studies also showed that pea protein conjugated with propylene glycol alginate and pectin had significantly improved functional properties.

Besides protein-polysaccharide conjugation, acylation is another chemical modification method that has been studied. Succinic anhydride and acetic anhydride are commonly used in the acylation modification of proteins. Acylation is a nucleophilic substitution reaction between acylating agents (e.g., succinic/acetic anhydride) with protein amino acid residues (particularly lysine), resulting in improved functional properties. A previous study demonstrated that acetylation and succinylation of pea protein improved emulsifying properties, foaming, and water holding capacity. Acylation modification has also been employed on other proteins, such as faba bean, chickpea, and mung bean.

Guar gum is derived from endosperm of Cyamopsis tetragonoloba, and it is a water soluble polysaccharide. Guar gum is widely used in the food industry due to its excellent water absorption and stabilizing and thickening properties. This study aims to improve pea protein functional properties in terms of water/oil holding capacity, foaming and emulsion properties, gelation, and solubility through acylation or/and conjugation with guar gum and understand the physicochemical characteristics and in vitro digestibility of the modified proteins.

### 2. Materials and Methods

### 2.1 Materials

Pea protein (83% protein content) was obtained from a commercial source. Guar gum (DeJa' GF Foods, Plain City, OH, USA) and soybean oil were purchased from Amazon. Acetic, succinic anhydrides, 8-anilinonaphthalene-1-sulfonic acid (ANS), β-mercaptoethanol, and other chemicals were purchased from Sigma-Aldrich (St. Louis, MO, USA).

### 2.2 Preparation of Modified Pea Protein

Acylated pea proteins were prepared by reacting the protein with acetic anhydride (AA) or succinic anhydride (SA) at 0.3 or 0.6 g of AA or SA per g protein in distilled water at 10 wt % protein concentration, respectively. The protein slurry was adjusted to pH 8 using 5 M NaOH and mixed for 1 hour at room temperature to allow reaction. After that, the sample was transferred into a dialysis bag (Nominal MWCO: 3500, Thermo Fisher Scientific, Waltham, MA, USA) for dialysis against distilled water at 4° C. for 48 hours to remove the residuals of acetic and succinic acids and salts. The distilled water used during the dialysis was changed every 10 hours. Then, the modified protein dispersion was lyophilized. All the dried protein powders were kept at 4° C. till further analysis.

The guar gum-pea conjugates were prepared through a wet heating Maillard reaction. Mixture of guar gum and pea protein (1:20 or 1:40 weight ratio) or acylated pea protein (1:20) was dispersed in distilled water at 10 wt % concentration, respectively. The mixture was mixed for 15 min at room temperature and then incubated in a water bath at 60° C. with continuous mixing for 24 hours. After that, the sample was lyophilized. All the dried protein powders were kept at 4° C. till further analysis.

### 2.3 Functional Properties

Protein functional properties including solubility, water holding capacity, oil holding capacity, and foaming capacity and stability were measured following our previous methods (Shen et al., 2021. Drying methods affect physicochemical and functional properties of quinoa protein isolate, Food Chemistry, Volume 339, sciencedirect.com/science/article/abs/pii/S030881462031685X) without modification. Emulsion capacity and stability were evaluated similarly to Shen et al. (2021), except that 1.0 g protein was dispersed in 50 mL 50:50 mixture of distilled water and soybean oil, instead of using 1.75 g protein.

The least gelation concentration (LGC) of pea proteins was evaluated following a previous method with minor modifications. The protein was added into 10 mL distilled water in 15 mL centrifuge tubes and thoroughly mixed to obtain a concentration from 2 to 20% (w/v). The protein suspension was heated at 100° C. for 1 hour, cooled under running cold tap water, and refrigerated at 4° C. for 2 hours. The LGC was considered as the concentration of protein dispersion that would not fall when the centrifuge tube was inverted.

### 2.4 Browning Reaction During Protein Conjugation

The measurement of browning reaction was conducted following our previous method (Shen, Chen, & Li, 2018). UV absorbances at 304 and 420 nm are considered as an indicator of the Amadori compound and melanoidin formation in protein-carbohydrate conjugates. The conjugated pea protein (50 mg) was dispersed in 4 mL distilled water in a centrifuge tube, which was vortexed for 10 seconds and further vigorously mixed for 30 min. After that, the dispersion was centrifuged at 10,000 xg for 10 min. The supernatant was obtained and analyzed using a double beam spectrophotometer (VWR UV-6300PC, VWR International, Radnor, PA, USA) at 304 and 420 nm.

### 2.5 Free Amino Group

Free amino group content of the modified pea proteins was measured following a previous method. One milliliter of protein sample solution (5 mg/mL) was added with 1 mL of 4% NaHCO₃ and 1 mL of 0.1% TNBS (2,4,6-trinitrobenzene sulfonic acid) in a centrifuge tube. The mixture was incubated in a water bath at 40° C. for 2 hours. After that, 1 mL of 10% (w/v) sodium dodecyl sulphate (SDS) was added to the mixture to solubilize the protein. Finally, the reaction was terminated by adding 0.5 mL 1 N HCl. The protein mixture was cooled at room temperature for 15 min, and absorbance at 340 nm was measured using the double beam spectrophotometer (VWR UV-6300PC). L-leucine was used as a standard to establish the calibration curve.

### 2.6 Surface Hydrophobicity and Fourier Transform Infrared Spectroscopy (FTIR)

Surface hydrophobicity information and FTIR spectra of the modified pea proteins were collected according to our previous method without modification (Shen et al., 2021).

### 2.7 Circular Dichroism (CD) Spectroscopy

Secondary structures of pea proteins were determined by using a Jasco J-815 circular dichroism spectrophotometer (Jasco Analytical Instruments, Easton, MD). The protein sample was dissolved in distilled water, which was further diluted to a certain concentration that could fit into the scanning regions. The protein solution was scanned from 190 to 250 nm. The following parameters were used: step interval 1 nm, acquisition duration 50 nm/min, and bandwidth 0.5 μm. The data were recorded and corrected by subtracting the water blank. The data of protein secondary structure was estimated using BeStSel.

### 2.8 Sodium Dodecyl Sulphate-Polyacrylamide Gel (SDS-PAGE) Electrophoresis

SDS-PAGE of the modified proteins under reducing condition was performed according to our previous method, except that the protein sample (5 mg/mL) was extracted using 1% SDS/sodium phosphate buffer (pH 7.0) with 2% 13-mercaptoethanol, instead of deionized water.

### 2.9 Free Sulfhydryl (SH) Content

The measurement of free SH groups was conducted following the method from a literature. Protein solution (5 mg/mL) was prepared by dissolving the protein in 0.05 M sodium phosphate sample buffer (pH 6.5), which consisted of 2% SDS (v/v), 3.0 M urea, and 1.0 mM tetrasodium ethylenediamine tetraacetate. Five mL of the prepared solution was added with 500 μL of 0.1% (w/v) DTNB Ellman's reagent (5,5-dithio-bis-(2-nitrobenzoic acid), followed by mixing vigorously for 45 min, and centrifugation at 10,000×g for 3 min. The absorbance was measured at 412 nm using the spectrophotometer (VWR UV-6300PC). Glutathione was used as a standard to establish the calibration curve.

### 2.10 In Vitro Digestibility

In vitro digestibility of the proteins were determined following a simulated gastric and intestinal digestion method from literature with some modifications. Briefly, 50 mg of protein was first dispersed in 20 mL of simulated gastric fluid solution, which contains 2.5 mM CaCl₂, 35 mM NaCl, and pepsin (182 U/ mg protein). The protein solution was acidified with HCl to pH 2, and digestion was continued at 37° C. for 1 hour in a water bath shaker. In vitro intestinal digestion was then carried out by adding 4 mL of simulated intestinal fluid containing 7.6 mM CaCl₂, 20.3 mM Tris, 7.4 mM bile salts, trypsin (40 U/mg protein), and chymotrypsin (0.5 U/mg protein) to the protein solution after the 1 hour gastric digestion. The pH of the protein solution was adjusted to 7 before incubating the sample in the water bath shaker for 2 hours. The digestion was stopped by heating the solution in boiling water for 5 min, cooled down, and centrifugated at 4500 rpm for 5 min. The supernatant was diluted with 100 mM sodium bicarbonate (1: 200, v/v), which was further mixed with OPA reagent (100 mM sodium tetraborate, 0.01% SDS, 0.05 mg/mL OPA, and 0.05 mg/mL DTT) (1:50, v/v). Finally, 200 μL of the solution was added in a 96-well plate, and the fluorescence was determined using a plate reader (excitation at 340 nm, emission at 450 nm) (BioTek, Synergy H1 Hybrid, Highland Park, Winooski, VT, USA). L-Leucine was used to establish a calibration curve. The DH% (degree of hydrolysis) was calculated according to the literature with hₜₒₜₐₗ factor of 7.8 based on soy.

### 2.11 Statistical Analysis

All the experiments were carried out in at least two replicates. Kruskal-Waillis non-parametric test and Conover-Iman procedure were used to analyze the specific sample pairs for stochastic dominance (p<0.05) among the treatments using Python 3.6 package scipy.stats (Python code and example are available in the Supplementary Document). The final results are presented as mean±standard deviation.

### 3. Results and Discussion

### 3.1 Protein Solubility

Protein solubility is considered as one of the most critical functionalities in food applications, because it is associated with many other functional properties, such as hydration, foaming, and emulsifying properties. Generally, all the modified pea proteins had greatly improved solubility compared with the unmodified pea protein above the isoelectric point (pI, around pH 5) (FIG. 1). Guar gum-pea conjugates (1:20 and 1:40) also showed much higher solubility below the pI, while the solubility of the acylated pea proteins was much lower below pH 5, especially that the succinylated pea proteins were barely soluble. Thus, we can conclude that conjugation modification with polysaccharide is highly effective in improving protein solubility. This is because when protein is conjugated with hydrophilic polysaccharide at the early stage of Maillard reaction, protein hydration properties are improved, therefore, enhancing the solubility. (Shen et al. (2018). Bread characteristics and antioxidant activities of Maillard reaction products of white pan bread containing various sugars. LWT, 95, 308-315. doi.org/10.1016/j.1 wt.2018.05.008; Shen et al. (2018). Effect of amino acids on Maillard reaction product formation and total antioxidant capacity in white pan bread. International Journal of Food Science & Technology. doi.org/10.1111/ijfs.14027.)

The succinylated pea protein had relatively higher solubility than the acetylated pea protein when the pH was greater than 5, and it had lower solubility when the pH was less than 5. This could be explained by the fact that the succinylation process replaced the ammonium groups from lysine residues, which resulted in fewer hydrophilic cation groups to counterbalance the protein-protein hydrophobic interactions. Therefore, protein-protein interaction was stronger below the pI, which reduced its solubility. When the pH was above 5, the replacement of c-amino group of lysine with negatively charged carboxyl groups enhanced the interaction between protein-water, and promoted the intra- and intermolecular charge repulsion, thus, resulting in unfolding and dissociation of the quaternary structures and increased solubility. Lower solubility of the acetylated pea proteins than the succinylated pea proteins above the pI was due to stronger aggregation between the unfolded protein via hydrophobic interactions. Our result was in agreement with other studies on the acylation of African yam bean protein, mung bean protein, oat protein, and rice protein.

### 3.2 Water/Oil Holding Capacities

Water and oil holding capacities (WHC, OHC) determine the water/oil retention of the proteins and protein-water/ oil interactions and affect texture and quality of food products. The WHC is also associated with other protein functional properties, such as solubility, emulsifying properties, and gelation. The physical mixture of guar gum-pea (1:20) had significantly higher WHC than the conjugated (1:20) and unmodified pea proteins (Table 1). Guar gum is a high molecular weight polysaccharide and strongly interacts with water, acting as a thickening agent, and the higher WHC was achieved by its stronger water binding ability. Higher concentration of guar gum (1:20 vs. 1:40) resulted in higher WHC for the simple guar gum/protein mixture and the conjugated proteins, because more hydrophilic polysaccharides enhanced the affinity between protein and water molecules. However, the WHC of the conjugated protein was not obviously improved compared with the unmodified protein, which was probably related to the surface hydrophobicity of the proteins (Table 2). Conjugated proteins with decreased surface hydrophobicity showed stronger WHC. Others have also reported that protein-polysaccharide conjugation did not increase the WHC of African yam bean and whey proteins; however, some reported that conjugated rapeseed protein had significantly increased WHC. Overall, the WHC of conjugated protein depends on the conjugation conditions, degree of conjugation, types of polysaccharide, and its surface hydrophobicity.

The WHC of acetylated and succinylated pea proteins increased significantly compared with the unmodified and conjugated pea proteins (Table 1). Acylation modification unfolds the protein and alters protein electrical charge distribution, resulting in enhanced hydrophilic binding site of the protein molecules. With increased concentration of acylation agents, there was no significant difference for the WHC of the succinylated pea proteins, but WHC of the acetylated protein decreased due to the conversion of protein net positive charge to neutral charge. Furthermore, AA-0.3 exhibited higher WHC than SA-0.3. The succinylated protein had higher solubility than the acetylated protein (FIG. 1); therefore, more succinylated proteins were dissolved in water instead of absorbing and holding the water. In addition, sequential acylation and conjugation had synergistic effect on WHC, especially for SA-0.6 conjugate, which exhibited the highest WHC of 10.91 g water/g protein among all the modified proteins.

All the modified proteins (i.e., conjugation, acylation, and sequential modification) had significantly higher OHC compared with the unmodified pea protein (Table 1). The conjugation modification had a greater effect on increasing the OHC, because the heat treatment during the protein-polysaccharide conjugation altered and unfolded the protein structure and exposed more hydrophobic amino acid residues of the protein. Overall, the succinylated pea proteins exhibited higher OHC than the acetylated pea proteins, while there was no significant difference for OHC among the modified proteins with different levels of the same modifier. In addition, the protein from sequential acylation and conjugation (SA 0.6 conj) showed the highest OHC among all the protein samples. Protein OHC could be affected by many factors, such as protein surface area, ratio of hydrophilicity/hydrophobicity, protein net charge, etc.

### 3.3 Emulsifying Properties

Overall, most modified pea proteins exhibited significantly higher emulsion capacity (EC) and emulsion stability (ES) compared with the unmodified pea protein, except for AA 0.3/0.6 (Table 1). Generally, the guar gum-pea protein conjugates had higher EC and ES compared with the simple mixtures at the same gum concentration, indicating that the protein-polysaccharide interactions induced through Maillard reaction are crucial in improving the emulsifying activity of the protein. Higher gum concentration in the modified proteins (1:20 conj vs. 1:40 conj) resulted in greatly enhanced emulsion stability (94.7% vs. 60.7%), which was attributed to the hydrophilicity of the polysaccharide. Conjugation of guar gum and protein caused the formation of strong solvated layer at the oil-water interface, which favored the steric stabilization of the emulsion oil droplet. The absorbed layer of conjugated protein has more effective steric stabilization of emulsion droplets than the unmodified protein.

Acetylation and succinylation had distinct effects on the EC and ES of pea protein. The EC and ES of AA 0.3/0.6 were significantly decreased, while the EC and ES of SA 0.3/0.6 were significantly increased compared with the unmodified pea protein (Table 1). The addition of longer aliphatic groups by succinylation increased the protein-water interaction, and exposed more hydrophobic residues of the protein; therefore, the emulsifying properties were significantly improved. The emulsifying properties were also positively related to protein solubility (FIG. 1). The succinylated protein could form more stable layers around the oil droplets to facilitate their interaction with aqueous phase because of higher solubility, and the emulsifying properties of the acetylated pea proteins were limited due to a lower solubility. Sequential acylation and conjugation modifications had exceptional synergistic effects on the emulsifying properties of the proteins, achieving nearly 100% EC and ES, except for AA 0.3 conjugate. The results showed that modification of protein structures by adding appropriate functional groups is highly effective in enhancing its functional properties.

### 3.4 Foaming Properties

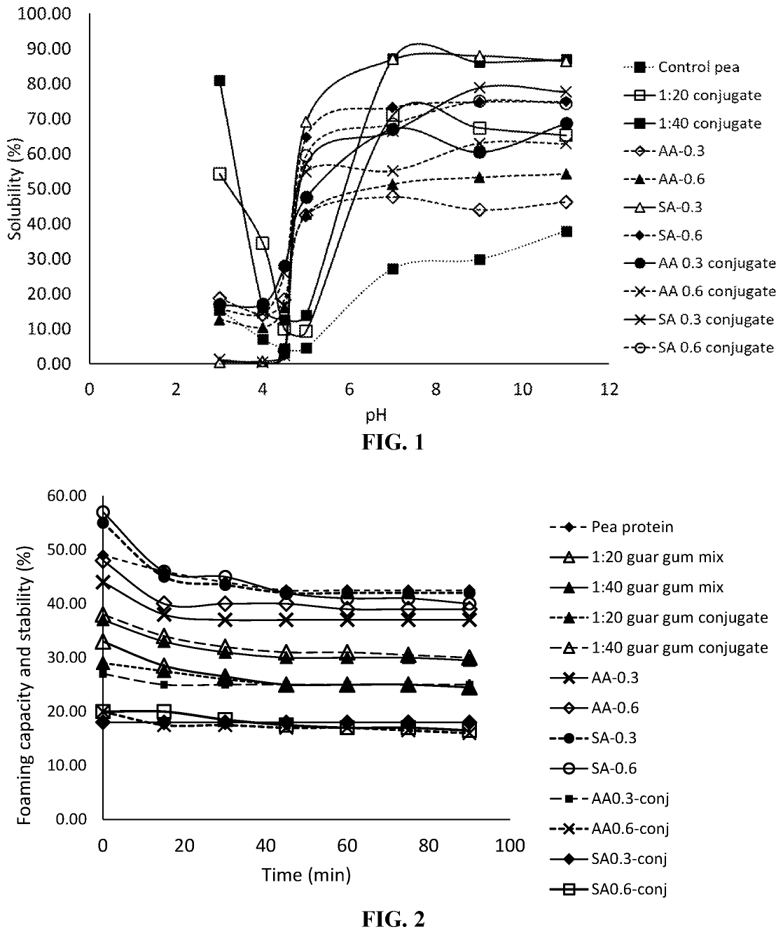

Important characteristics of protein foaming properties include foaming capacity (FC) and foaming stability (FS). Foaming capacity is determined by the amount of interfacial area that can be created by the protein, and it is highly related to protein hydrophobicity, while foaming stability indicates its ability against stress during a certain period of time. Foam formation is dependent on the interfacial film that is formed by the proteins and the ability to maintain the air bubble in the suspension and slow down the coalescence rate (Shen et al., 2021). In this study, most of the modified pea proteins showed decreased FC and FS compared with the unmodified pea protein, except for SA 0.3/0.6 (FIG. 2). The conjugated proteins had much lower FC and FS than the acylated proteins. The higher FC of succinylated pea proteins may be attributed to their smaller molecular size and better solubility, so they could be more rapidly absorbed during the whipping process to generate more foams compared with the conjugated proteins with higher molecular weight and lower solubility.

When comparing different guar gum-pea protein conjugates, the 1:40 conjugate exhibited better FC and FS than the 1:20 conjugate; however, the foaming properties of both conjugates were weaker than that of the unmodified protein. The results implied that the addition of high molecular weight polysaccharide conjugated with the protein does not help in improving foaming properties. Other studies also found that some excessive modification of proteins could cause foam destabilization and poor stability due to the increase of net charge density, reduce the protein-protein interaction in the foam lamellae, and prevent the formation of elastic film in the air-water interface.

### 3.5 Gelation Property

Protein gelation is important in determining the texture, quality and sensory attributes of many foods. Overall, gelation properties of all the modified pea proteins were significantly enhanced with lower least gelation concentration (LGC) values compared with the unmodified pea protein (Table 1). The 1:20 protein conjugate had significantly decreased LGC compared with the simple protein-gum mixture (1:20), and both of them had better gelation properties than the 1:40 conjugate and mixture. This is because the addition of higher amount of hydrocolloid improved gel thickening function of the protein, and unfolding of the protein through conjugation enhanced protein hydrophobic interaction in the formation of more stable gel network, reducing the amount of proteins required for gel formation. Some reported that only moderate degree of conjugation of rapeseed protein with dextran could improve the gelation properties, while excessive conjugation decreased gelation properties, because additional static space was created between the conjugated protein molecules with polysaccharide coating, which inhibited protein hydrophobic interaction. The acetylated pea proteins exhibited significantly lower LGC values, and thus better gelation properties, compared with the succinylated proteins. During the acetylation process, the protein was unfolded and disulfide crosslinking was enhanced, improving the gelation properties. Furthermore, sequential acetylation and conjugation dramatically decreased the LGC, especially for the AA 0.6 conjugate, which formed stable gets at only 7% concentration. The result demonstrated that synergistic effect occurred when combining both modifications.

### 3.6 Browning Reaction

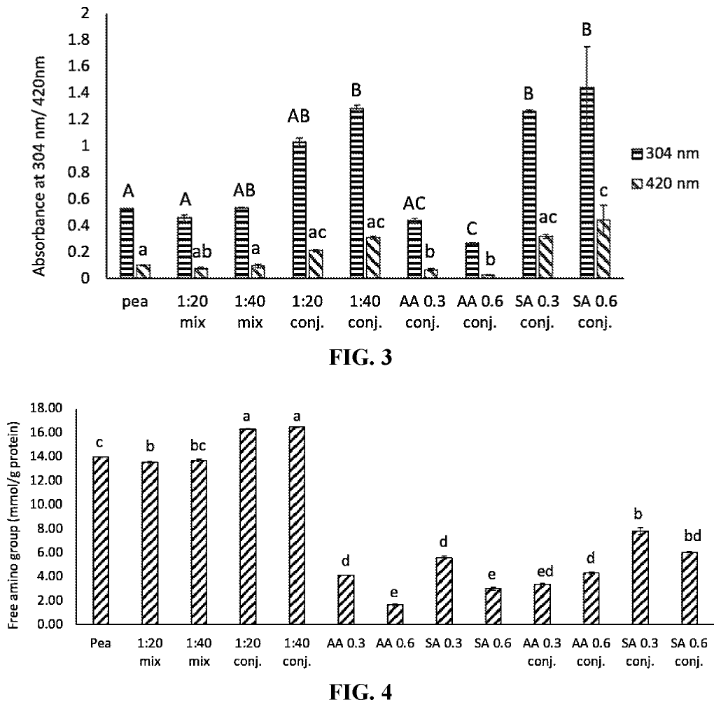

The relative amount of browning compounds generated during the conjugation reaction in the modified proteins was measured based on the absorbance at 304 nm (early intermediate Amodari compounds) and 420 nm (final Maillard reaction products), respectively. Generally, the conjugated proteins had significantly higher absorbance at 304 nm compared with the unmodified protein (FIG. 3), but the absorbances at 420 nm were similar, which implied that majority of the protein-polysaccharide conjugates belongs to the early intermediates of Maillard reaction products. The 1:40 conjugate had relatively higher absorbance at 304 nm than the 1:20 conjugate. This may be caused by the formation of more browning compounds with higher amount of proteins in the 1:40 conjugate during the Maillard reaction. Browning reaction depends on the conjugation conditions, such as reaction temperature, time, and the ratio of protein/polysaccharides. The simple guar gum-pea protein mixtures and unmodified protein had similar absorbance at 304 and 420 nm, because conjugation reaction was not expected for the mixtures as they were prepared at room conditions by simply mixing (FIG. 3).

### 3.7 Free Amino Group Content

The amount of available free amino group is another indicator of the degree of protein acylation and guar gum-protein conjugation. The acylated proteins had significantly lower amount of free amino group compared with the unmodified pea proteins (FIG. 4). This is because the acylation reaction mainly occurred between the acylating agent and free amino groups of the proteins, although reactions could also occur with other amino acid residues such as cysteine, tyrosine, serine and/or threonine. The succinylated proteins had a significantly higher amount of free amino group than the acetylated proteins with the same amount of acylation agent. When AA and SA were added at the same weight amount, more intensive reactions were expected for AA because of its higher molar ratios to protein and stronger reactivity. Although conjugation reaction occurred between carbonyl groups of polysaccharides and amino groups of protein, the amount of free amino group of the conjugated proteins was not reduced compared with that of the unmodified protein. This was caused by the interfered absorbance of guar gum molecules that was overlapped with the absorbance of the conjugated proteins during free amino measurement. In addition, we used a much lower amount of polysaccharide relative to the protein (1:20 and 1:40); therefore, relatively much less amount of free amino group was consumed during the conjugation modification.

### 3.8 Surface Hydrophobicity

Surface hydrophobicity of protein is dominated by the hydrophobic amino acid group residues available at the surface of protein. The guar gum-pea protein conjugates had greatly larger (p<0.05) surface hydrophobicity compared to the unmodified pea protein (Table 2). This is because the inclusion of polysaccharide to the protein led to protein unfolding and exposure of more hydrophobic residues. However, the surface hydrophobicity of 1:20 conjugate was lower than that of the 1:40 conjugate, which may be attributed to the intrinsic hydrophilicity of the polysaccharide. Both the acetylated and succinylated pea proteins had significantly lower surface hydrophobicity than the unmodified pea protein, although higher level of modifier resulted in slightly higher surface hydrophobicity (Table 2). Acylation modification of the protein introduced succinyl and acetyl groups onto the protein, which increased the electronegativity and enhanced the electronic repulsion, and this prevented ANS probe from binding to the protein hydrophobic area, thus showing decreased surface hydrophobicity. A similar trend was reported for acylated oat proteins. Relatively higher surface hydrophobicity was observed for the succinylated protein compared with the acetylated protein with the same amount of modifier (Table 2), which is because of the more hydrophobic nature of the succinic group than the acetic group. Furthermore, the conjugated SA 0.3 and SA 0.6 had significantly higher surface hydrophobicity than the unmodified pea protein and succinylated proteins, which indicated that the conjugation had stronger effect in improving the hydrophobicity.

### 3.9 FTIR

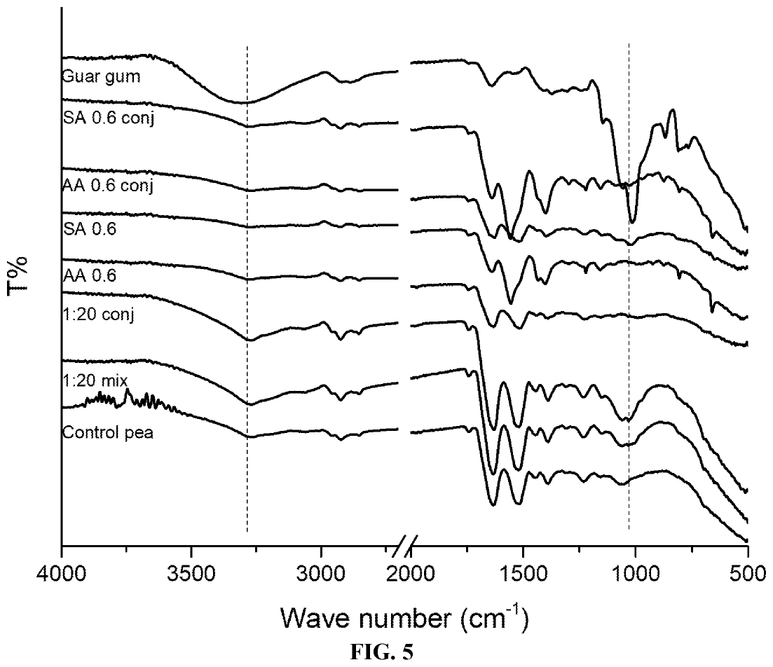

Fourier transform infrared spectroscopy is useful in identifying protein functional groups and secondary structures after modification. The bands in the regions of 3700-3200 cm⁻¹ and 1100-1000 cm⁻¹ denote the hydroxyl group and C-O stretching vibration, respectively. There were obvious differences when comparing the conjugated proteins with the unmodified protein (FIG. 5). After protein conjugation with guar gum, it showed more intensive bands at 3700-3200 cm⁻¹ than the unmodified pea protein and the sequential acylated and conjugated proteins (AA 0.6/ SA 0.6 conjugates) (FIG. 5). A strong band at 1100 -1000 cm⁻¹ was attributed to —OH bending vibration in the conjugated protein. Acylation modification greatly altered the protein secondary structures, which was related to the bands of amide I, II and III, attributed to 1635 cm⁻¹, 1546 cm⁻¹ and 1450-1240 cm⁻¹, which defined the C═O stretching, N—H deformation, C—N stretching and N-H bending vibrations, respectively.

### 3.10 Circular Dichroism (CD) Spectroscopy

Secondary structures of the modified pea proteins including α-helix, β-sheet, β-turn, and random coil obtained from CD are summarized in Table 2. The unmodified pea protein consisted of 17.17% of α-helix, 23.97% of β-sheet, 1.17% of β-turn, and 57.67% of random coil, and random coil accounted for the majority of the secondary structures. The conjugated proteins (both 1:20 and 1:40 conjugates) had significantly higher amount of α-helix, but lower amounts of β-sheet and random coil compared with the unmodified pea protein. Some reported a slight decrease in α-helix and β-sheet structures, but an increase in random coil in the rice protein conjugated with k-carrageenan. Others reported that the amount of both α-helix and random coil of peanut protein-dextran conjugates was decreased, while β-sheet structure was increased. The secondary structural differences could be attributed to the different protein types, reaction conditions, and the ratio of polysaccharide to protein. The acetylated pea protein had relatively lower amount of α-helix but much higher amount of β-turn structure. The succinylated pea protein possessed significantly higher amount of β-sheet structure but lower amount of random coil compared with the unmodified or conjugated pea proteins. Our results confirmed that conjugation and acylation can greatly alter protein secondary structures and further affect the functional properties.

### 3.11 SDS-PAGE

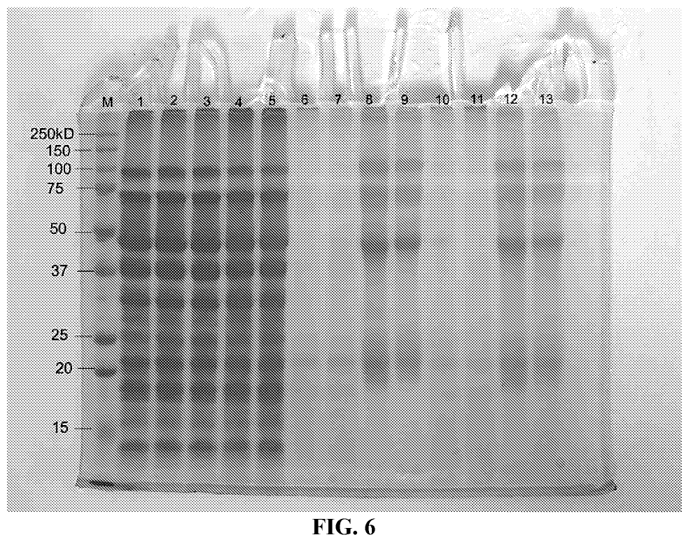

Globulins, including both legumin (11S) and vicilin (7S), are the major storage protein in pea. There was no obvious difference when comparing the SDS-PAGE bands of the gum-pea conjugates and the unmodified pea protein (FIG. 6). This result was expected, because extremely small amount of polysaccharide relative to the protein was used for the conjugation modification, and changes of protein molecular size could not be observed from the electrophoresis. The succinylated proteins exhibited more intensive bands compared with the acetylated proteins. Although a strong solvent (i.e., SDS/sodium phosphate buffer) was used to dissolve the protein samples prior to the electrophoresis analysis, the acetylated protein still showed very low solubility due to the greatly reduced electronegativity by introducing acetic functionality, which is consistent with the solubility result (FIG. 1). The 11S is a hexameric protein consisting of acidic (40 kDa) and basic (20 kDa) subunits, and the 7S is a glycosylated trimeric cluster consisting of three subunits, with molecular weight of 47.3, 33.3, and 28.7 kDa, respectively, all of which were observed on the SDS-PAGE under the reducing condition. The band at around 100 kDa was attributed to lipoxygenase and may also indicate the formation of newly crosslinked protein structures during processing.

### 3.12 Free Sulfhydryl (SH) Group

The content of free sulfhydryl group in pea and modified pea proteins is summarized in Table 2. There was no significant difference for the free SH content between guar gum-pea protein conjugates and the unmodified pea protein, indicating that no or very minimal disulfide crosslinking occurred during the conjugation. Acetylated pea proteins (both AA 0.3/0.6 and AA 0.3/0.6 conjugates) had significantly lower free SH content compared with the unmodified protein, implying intensive disulfide crosslinking during acetylation modification. It was reported that conjugation reaction reduced the free sulfhydryl groups in pea, whey, and rapeseed proteins, respectively, because heat treatment during the Maillard reaction promoted the formation of disulfide linkages. The different result from our study was attributed to the different conjugation conditions, such as reaction temperature, time, and ratio of polysaccharide to protein.

### 3.13 In Vitro Digestibility

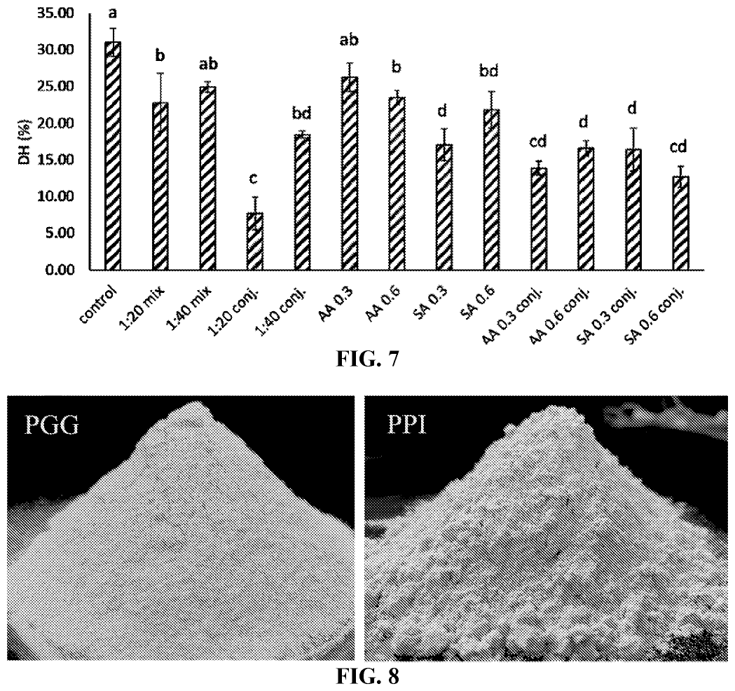

The in vitro digestibility of pea and the modified pea proteins was indicated by the degree of hydrolysis, and the results are presented in FIG. 7. Overall, the conjugated (1:20 conj and 1:40 conj) and acylated pea proteins (AA 0.6, SA 0.3, SA 0.6) showed decreased protein digestibility, while the digestibility of AA 0.3 was not significantly different compared with the control pea protein. The digestibility of the conjugated pea proteins was also decreased, because the conjugated protein had higher molecular weight, which became less accessible to the digestive enzymes. However, some literatures reported that the acylated proteins had increased digestibility compared with control protein, and this was attributed to their better solubility and unfolded molecular structures during modification.

### 4. Conclusions

In this study, modified pea proteins were prepared by acylation or/and conjugation through reacting with acetic anhydride (AA) or succinic anhydride (SA) and incubating the guar gum-pea protein mixtures to induce Maillard reaction, respectively. Both conjugated and acylated pea proteins demonstrated significantly improved OHC, and the acylated pea protein also had much greater WHC. The EC and ES of the modified proteins were improved by up to 112% and 140%, respectively, compared to the unmodified protein. Sequential acylation and conjugation of pea proteins demonstrated more beneficial and synergistic effects and further enhanced the WHC, OHC, emulsification and gelation properties, which could be used as novel plant protein ingredients for different applications. However, the in vitro digestibility of the modified pea protein was decreased compared to the control protein. Future research is necessary to conduct safety evaluation of the chemically modified proteins and further understand protein nutritional changes during the modification.

TABLE 1
Functional properties of pea proteins.

| | WHC (g H₂0/g | OHC (g Oil/g | | | |
|---|---|---|---|---|---|
| | protein) | protein) | EC (%) | ES (%) | LGC (%) |
| Pea | 3.57 ± 0.05^{f} | 1.03 ± 0.02^{d} | 45.08 ± 1.44^{dc} | 39.66 ± 0.76^{d} | 18^{a} |
| 1:20 mix | 5.20 ± 0.20^{cd} | 1.07 ± 0.01^{d} | 96.69 ± 0.99^{c} | 67.86 ± 5.02^{c} | 13^{d} |
| 1:40 mix | 4.09 ± 0.07^{de} | 1.06 ± 0.01^{d} | 67.54 ± 1.95^{c} | 54.46 ± 1.02^{cd} | 15^{b} |
| 1:20 conj. | 3.61 ± 0.11^{ef} | 2.02 ± 0.05^{bc} | 98.75 ± 0.56^{b} | 94.73 ± 0.58^{bc} | 11^{e} |
| 1:40 conj. | 2.67 ± 0.06^{f} | 2.20 ± 0.23^{ab} | 95.57 ± 0.56^{c} | 60.67 ± 1.73^{c} | 15^{b} |
| AA 0.3 | 7.01 ± 0.31^{ab} | 1.72 ± 0.01^{cd} | 41.60 ± 1.06^{d} | 34.79 ± 3.58^{e} | 9^{g} |
| AA 0.6 | 5.03 ± 0.06^{d} | 1.63 ± 0.03^{d} | 38.48 ± 1.87^{d} | 33.72 ± 3.26^{e} | 11^{e} |
| SA 0.3 | 5.68 ± 0.25^{c} | 2.09 ± 0.03^{b} | 99.00 ± 0.39^{b} | 96.65 ± 0.59^{b} | 14^{c} |
| SA 0.6 | 6.31 ± 0.65^{bc} | 1.88 ± 0.05^{c} | 99.14 ± 0.31^{b} | 95.63 ± 0.66^{b} | 14^{c} |
| AA 0.3 conj. | 5.79 ± 0.21^{b} | 1.76 ± 0.02^{cd} | 100.00 ± 0^{a} | 53.73 ± 1.23^{d} | 9^{g} |
| AA 0.6 conj. | 7.78 ± 0.15^{a} | 1.85 ± 0.05^{c} | 100.00 ± 0^{a} | 100 ± 0^{a} | 7^{h} |
| SA 0.3 conj. | 3.74 ± 0.24^{ef} | 2.18 ± 0.11^{ab} | 100.00 ± 0^{a} | 99.08 ± 0.34^{a} | 10^{f} |
| SA 0.6 conj. | 10.91 ± 0.63^{a} | 2.88 ± 0.05^{a} | 100.00 ± 0^{a} | 98.69 ± 0.55^{a} | 10^{f} |

Note:
WHC: water holding capacity; OHC: oil holding capacity; EC: emulsion capacity; ES: emulsion stability; LGC: least gelation concentration.
*Means with different letters for each functional attribute denote significant differences (p < 0.05).

TABLE 2
Surface hydrophobicity, free S—H content, and protein secondary structures.

| | | Free S—H | | | | |
|---|---|---|---|---|---|---|
| Protein | Surface | (μmol/g | | | | random coil |
| samples | hydrophobicity | protein) | α-helix (%) | β-sheet(%) | β-turn (%) | (%) |
| Pea | 72,543 ± 3,720^{a} | 5.42 ± 0.22^{a} | 17.17 ± 1.37^{a} | 23.97 ± 1.53^{a} | 1.17 ± 1.53^{a} | 57.67 ± 1.33^{a} |
| 1:20 mix | 116,861 ± 2,343^{b} | 4.56 ± 0.45^{ab} | 33.97 ± 9.85^{b} | 32.53 ± 11.04^{ab} | / | 33.53 ± 20.75^{ab} |
| 1:40 mix | 160,597 ± 5,462^{c} | 5.09 ± 0.13^{ab} | 21.23 ± 2.22^{ab} | 25.60 ± 3.03^{a} | / | 53.17 ± 4.81^{a} |
| 1:20 conj. | 152,126 ± 7,239^{bc} | 5.06 ± 0.17^{ab} | 42.87 ± 5.99^{b} | 13.97 ± 7.74^{a} | / | 43.17 ± 13.58^{b} |
| 1:40 conj. | 178,954 ± 6,750^{c} | 5.49 ± 0.00^{a} | 53.47 ± 9.60^{b} | 15.63 ± 4.17^{a} | / | 30.90 ± 10.76^{b} |
| AA 0.3 | 18,885 ± 2,336^{d} | 0.87 ± 0.06^{b} | 19.90 ± 0.40^{a} | 20.10 ± 3.93^{a} | 16.40 ± 0.82^{ab} | 43.60 ± 5.02^{ab} |
| AA 0.6 | 35,482 ± 2,255^{ae} | 0.86 ± 0.02^{b} | 10.63 ± 2.49^{a} | 34.00 ± 7.53^{b} | 15.87 ± 2.57^{ab} | 41.10 ± 2.56^{b} |
| SA 0.3 | 33,416 ± 3,151^{e} | 5.69 ± 0.82^{a} | 31.93 ± 9.76^{b} | 55.83 ± 8.33^{b} | / | 12.30 ± 16.86^{b} |
| SA 0.6 | 52,467 ± 3,024^{a} | 4.17 ± 0.68^{ab} | 18.47 ± 2.59^{ab} | 51.97 ± 6.52^{b} | / | 29.53 ± 7.91^{b} |
| AA 0.3 conj. | 24,606 ± 1,666^{ed} | 0.82 ± 0.00^{b} | 18.37 ± 2.77^{a} | 26.07 ± 3.52^{b} | 15.40 ± 4.25^{ab} | 40.20 ± 1.73^{b} |
| AA 0.6 conj. | 21,801 ± 1,685^{d} | 0.84 ± 0.08^{b} | 10.63 ± 4.54^{a} | 31.50 ± 2.10^{ab} | 16.87 ± 3.49^{b} | 40.73 ± 1.01^{ab} |
| SA 0.3 conj. | 109,611 ± 2,506^{b} | 5.28 ± 0.32^{a} | 25.90 ± 4.99^{b} | 45.40 ± 9.69^{b} | / | 28.70 ± 14.56^{b} |
| SA 0.6 conj. | 94,011 ± 3,939^{a} | 3.55 ± 0.43^{ab} | 15.33 ± 0.85^{a} | 34.50 ± 3.69^{ab} | 1 | 50.23 ± 4.46^{ab} |

*Means with different letters in each column denote significant differences (p < 0.05).

TABLE 3
Functional properties of commercial soy protein isolate and modified soy protein isolate,
(WHC: water holding capacity; OHC: oil holding capacity; EC: emulsion capacity; ES:
emulsion stability; LGC: least gelation concentration; FC: foaming capacity; and solubility).
Soy protein isolate

| | WHC | OHC | | | | | |
|---|---|---|---|---|---|---|---|
| | (g H2O/g | (g/Oil/g | | | | | |
| Sample | protein) | protein) | EC (%) | ES (%) | LGC | FC | Solubility |
| Soy control | 1.54 ± 0.00 | 1.55 ± 0.05 | 49.49 ± 0.72 | 46.43 ± 5.05 | 20+ | 92% | 69% |
| 1:20 conj. | 2.83 ± 0.00 | 3.08 ± 0.03 | 70.00 ± 4.71 | 61.43 ± 0.80 | 11 | 112% | 80.95% |
| AA 0.6 conj. | 5.23 ± 0.10 | 3.01 ± 0.04 | 99.17 ± 0.36 | 97.51 ± 0.29 | 12 | 40% | 79.99% |
| SA 0.6 | 8.25 ± 0.03 | 2.50 ± 0.10 | 100.00 ± 0.00 | 98.57 ± 0.40 | 20+ | 72% | 60.97% |
| SA 0.6 conj. | 5.87 ± 0.24 | 3.14 ± 0.04 | 100.00 ± 0.00 | 100.00 ± 0.00 | 14 | 40% | 86.41% |

TABLE 4
Functional properties of commercial chickpea protein concentrate and modified chickpea proteins,
(WHC: water holding capacity; OHC: oil holding capacity; EC: emulsion capacity; ES:
emulsion stability; LGC: least gelation concentration; FC: foaming capacity; and solubility).
Chickpea protein concentrate

| | WHC | OHC | | | | | |
|---|---|---|---|---|---|---|---|
| | (g H2O/g | (g/Oil/g | | | | | |
| Sample | protein) | protein) | EC (%) | ES (%) | LGC | FC | Solubility |
| Chickpea | 3.99 ± 0.09 | 1.40 ± 0.18 | 56.13 ± 0.18 | 52.13 ± 0.06 | 13 | 50% | 40.83% |
| control | | | | | | | |
| 1:20 conj. | 4.15 ± 0.15 | 3.85 ± 0.11 | 100.00 ± 0.00 | 100.00 ± 0.00 | 10 | 22% | 72.81% |
| AA 0.6 conj. | 6.63 ± 0.13 | 3.32 ± 0.01 | 100.00 ± 0.00 | 100.00 ± 0.00 | 9 | 28% | 81.52% |
| SA 0.6 | 6.94 ± 0.03 | 2.99 ± 0.03 | 99.49 ± 0.01 | 97.18 ± 0.06 | 13+ | 52% | 25.13%* |
| SA 0.6 conj. | 16.22 ± 0.01** | 3.91 ± 0.01 | 100.00 ± 0.00 | 98.12 ± 0.17 | 13 | 10% | 71.39% |

Note:
**High WHC of this treatment was due to a limitation of the testing method (actual WHC is lower than this value).
*Low solubility may due to the high fat content in the commercial chickpea protein (21.7%) that caused a false interpretation due to the limit of the testing method; actual solubility would be much higher than this.

TABLE 5
Functional properties of lab extracted pea protein isolate and
modified pea proteins through clean-label approaches, (WHC: water
holding capacity; OHC: oil holding capacity; EC: emulsion capacity;
ES: emulsion stability; LGC: least gelation concentration).
Lab extracted pea protein isolate

| | WHC | OHC | | | |
|---|---|---|---|---|---|
| | (gH2O/g | (g/Oil/g | | | |
| Sample | protein) | protein) | EC (%) | ES (%) | LGC |
| Pea control* | 2.66 ± 0.06 | 2.76 ± 0.05 | 58.58 ± 2.21 | 48.14 ± 1.77 | 11% |
| Pea-protein | 3.62 ± 0.04 | 2.68 ± 0.08 | 63.46 ± 4.95 | 51.91 ± 0.95 | 15% |
| glutaminase | | | | | |
| Pea- | 5.31 ± 0.08 | 3.08 ± 0.03 | 94.51 ± 0.33 | 57.69 ± 1.39 | 11% |
| tranglutaminase | | | | | |
| Pea-guar gum | 3.62 ± 0.04 | 2.62 ± 0.04 | 97.94 ± 0.34 | 96.31 ± 0.95 | 9% |
| Pea-gum arabic | 2.66 ± 0.01 | 2.50 ± 0.06 | 57.79 ± 4.05 | 52.11 ± 2.81 | 13% |
| Pea-PG-guar | 5.06 ± 0.02 | 3.36 ± 0.05 | 100.00 ± 0.00 | 97.74 ± 0.08 | 12% |
| Pea-PG-arabic | 3.27 ± 0.03 | 2.75 ± 0.04 | 67.57 ± 1.48 | 56.71 ± 2.15 | 15% |
| Pea-TG-guar | 5.62 ± 0.04 | 2.98 ± 0.07 | 100.00 ± 0.00 | 100.00 ± 0.00 | 9% |
| Pea-TG-arabic | 5.21 ± 0.06 | 2.70 ± 0.02 | 66.51 ± 4.65 | 54.62 ± 1.97 | 9% |

Note:
*different functional values for the pea protein isolate control in Table 4 and Table 1 were caused by the different sources (lab extraction vs. commercial supplier) and processing methods (e.g., freeze dry vs. spray dry) of the protein.

### Example 2

### Effect of Adding Pea Proteins as Functional Extender on the Cookability, Texture, and Sensory Properties of Beef Patties

### Abstract:

Plant-based ingredients such as flours or proteins are used as extenders, fillers, or binders in meat products to enhance nutrition, improve some quality attributes, and reduce cost. Modified pea protein through sequential deamidation and conjugation (PGG) exhibited greatly enhanced water/oil holding capacity, emulsification and gelling properties, and solubility than the original pea protein (PPI) (FIG. 8). The objective of this study was to understand the effect of adding 2.5 and 5% PPI or PGG on the cookability, physical and texture properties, and sensory attributes of beef patties in comparison with regular beef patty (i.e., no plant protein addition). Patty cooking loss, color, compressed juiciness, textural profile, shear force, moisture retention, and fat retention were characterized. Descriptive sensory analysis of grilled patties with trained panelists were also conducted. The beef patties containing PGG (especially at 5%) showed significantly decreased cooking loss (20%) and increased moisture and fat retentions compared with the control patty (33% cooking loss). In general, PPI patties exhibited harder texture (e.g., hardness, chewiness, shear force) than the control patty, while PGG patties showed much softer texture than the control. Sensory results indicated that the control patty had higher scores of juiciness, flavor, and beef flavor intensity and less off flavor than the extended patties, while the PGG patties were tenderer and softer than the control and PPI patties. Thus, the patties containing PGG demonstrated some advantageous features over the control patty in terms of higher fat/water retention and cooking yield and softer and tender texture, which may be preferred by the elderly or some other individuals. This study will benefit researchers and food professionals interested in developing and utilizing novel plant protein ingredients.

### 1. Introduction

There has been increasing demand for high-quality meat products with excellent eating quality, nutritional benefits, and lower cost. Beef products account for a quarter of total meat consumption in the U.S., with annual beef consumption of 58 pounds per person in 2021. Non-meat ingredients are commonly added into meat products to reduce cost, enhance nutritional quality, and improve some quality attributes. Various types of functional ingredients such as starch, protein, fiber, and hydrocolloid, are used as extenders, fillers, or binders in meat products to increase cooking yield and water/oil retention capacity, optimize meat texture, bind among meat pieces, and stabilize water and fat components in meat emulsion during food preparation and cooking.

Plant proteins are popular binders and extenders in meat products. They may enhance the emulsification of fat in comminute meat and bind fat and meat pieces in coarse ground meat products, which can deliver more structural integrity and functionality for meats. Extension of meat systems with plant protein results in a complex heterogeneous structure and alters the physical and textural characteristics of the meat products. Soy protein with good gelling and emulsifying properties has been used in meatball, sausages, and burgers for cost reduction and textural improvement. Others found that pork burger added with 2% soy protein isolate had significantly improved textural properties, such as cohesiveness, springiness, and chewiness. A similar finding was also reported, which showed that beef sausage containing texturized protein had increased cooking yield and decreased hardness; in addition, the sensory attributes were not affected with up to 30% substitution with the protein. Others reported that beef patties added with glutinous rice flour had decreased cooking loss, increased fat and moisture retention, and improved patty juiciness and tenderness compared with the regular patty.

Pea (Pisum sativum L.) is attracting increasing interest as a promising protein crop due to its many agronomic and food functional advantages. However, commercial utilization of pea protein products is still relatively limited, partially due to their less desirable functional and sensory properties. To overcome these limitations, protein modifications can be a useful strategy to improve the functionalities, for example, solubility, emulsifying properties, gelation, and water/oil holding capacities. For example, glutaminase deamidation of coconut protein and wheat protein increased the negative charge of proteins by converting amide groups in glutamine and asparagine residues to carboxyl groups, resulting in improved functional characteristics. As shown in Example 1, pea protein and guar gum conjugation through Maillard reaction enabled the protein to be covalently linked with hydrophilic polysaccharide, which significantly improved protein solubility and emulsifying properties. Example 1 exemplifies a modified pea protein developed through sequential enzymatic modification of pea protein isolate (PPI) with protein glutaminase and conjugation with guar gum, namely PGG. This “clean label” modification approach exhibited synergistic advantages, and the modified pea protein PGG possessed excellent emulsification capacity, gelation property, and oil holding capacity. The new pea protein ingredient may have a better potential as functional extender in processed meat products. Therefore, this study aimed to understand the effect of adding original (i.e., PPI) or functionally enhanced pea protein (PGG) on the cookability, physical and texture properties, and sensory attributes of beef patties in comparison with regular beef patty (i.e., no plant protein addition). Patty color, cooking loss, compressed juiciness, textural profile, shear force, moisture retention, and fat retention were characterized. Descriptive sensory analysis of grilled patties with trained panelists were also conducted. This study will benefit researchers and food professionals interested in developing and utilizing novel plant protein ingredients.

### 2. Materials and Methods

### 2.1 Materials

Ground beef (80% lean/ 20% fat) was purchased from a local grocery store. Pea protein isolate (PPI, 83% protein content) was obtained from a commercial source. Guar gum was purchased from Judee's (Plain City, OH, USA). Protein glutaminase was provided by Amano Enzyme Inc (Nagoya, Japan). Other chemicals and reagents of analytical grade were purchased from Sigma-Aldrich (St. Louis, MO, USA).

### 2.2 Preparation of Functionally Enhanced Pea Protein

The functionally enhanced pea protein (PGG) was prepared through a sequential modification of PPI with protein glutaminase and guar gum. Briefly, the PPI (10% protein concentration) was continuously mixed with 1% protein glutaminase (PPI basis) at pH 6.5 in a water-bath shaker at 55° C. for 3 hours to allow deamidation reaction. The slurry was then boiled for min to deactivate the enzyme and cooled down. After that, 5% guar gum (PPI basis) was added for conjugation reaction at 60° C. for 24 hours with continuous mixing. At the end, the protein slurry was lyophilized, and the dried protein sample was ground and kept at 4° C. for further analysis and usage.

### 2.3 Analysis of Protein Functional Properties

Protein functional properties of PPI and PGG, including water/ oil holding capacity, emulsion capacity and stability, least gelation concentration, and solubility were measured following our previous methods in Example 1 without any modification.

### 2.4 Preparation of Beef Patties Containing Pea Proteins

Five patty treatments were designed for this study, including control patty (without pea protein) and patties with 2.5 or 5% PPI and PGG. Raw beef patties were prepared by hand mixing the ground beef with protein and then mounding to a round shape, with approximately 30 g per patty. The raw patties were cooked on a grill until reaching internal temperature of 160° F. A total of 14 replicate patties were prepared for each treatment and used for the following tests: patty 1-10 for color measurement, patty 1-11 for cooking loss, patty 1-4 for TPA analysis, patty 5-6 were for shear force test, patty 7-8 for pressed juiciness test, and patty 9-13 for moisture and fat retention measurements.

### 2.5 Color Measurement

Color parameters of raw beef patties were measured using a digital precise colorimeter (CIELAB, XITIAN machine equipment Co., Ltd, Huizhou, China) to obtain the L*, a*, and b* values. Each beef patty was scanned twice at different locations on the surface, and each patty treatment was tested in ten replicates.

### 2.6 Measurement of Cooking Loss, Moisture Retention, and Fat Retention

Cooking loss was measured based on weight differences between a raw patty and the cooked patty according to the equation below:

$$Cooking loss ( \% ) = \frac{( raw weight ) - ( cooked weight )}{( raw weight )} \times 100$$

Moisture content of beef patty (both raw and cooked) was measured according to AOAC 950.46 (AOAC, 2019), and the patty sample was dried at 135° C. for 2 hours. Fat content of beef patty (both raw and cooked) was measured according to AOAC 960.39 with small modifications. Briefly, beef patty was lyophilized, and the fat in the patty was extracted with ethyl ether for two times. The ether extract was combined and allowed to evaporate the solvent in a fume hood overnight. Moisture and fat retentions were calculated according to the following equations:

$$Moisture retention ( \% ) = \frac{( cooked weight ) \times ( moisture \% in the cooked patty )}{( raw weight ) \times ( moisture \% in the raw patty )} \times 100$$

$$Fat retention ( \% ) = \frac{( cooked weight ) \times ( fat \% in the cooked patty )}{( raw weight ) \times ( fat \% in the raw patty )} \times 100$$

### 2.7 Texture Profile Analysis (TPA)

Texture profiles of the cooked beef patty were measured using a TA-XT Plus texture analyzer (Stable Micro System, Godalming, Surrey, UK) with a cylinder probe with two-inch diameter. The measuring parameters were set as: 1.0 mm/s pre-test speed, 5.0 mm/s post-test speed, 1.0 mm/s test speed, and 50% strain compression with 20 g trigger force. Each patty treatment was conducted in four replicates. Patty textural parameters including hardness, resilience, cohesiveness, springiness, and chewiness were recorded by the equipped software and collected.

### 2.8 Shear Force Measurement

For shear force test, 2-cm wide strips were cut from cooked patties, and the strip was sheared perpendicularly to the patty surface using a Warner-Bratzler blade set attached to the Texture Analyzer (Stable Micro System, Godalming, Surrey, UK) with test speed at 5 mm/sec. The value of shear force was collected as the maximal force during shearing. Each patty treatment was analyzed in four replicates.

### 2.9 Compressed Juiciness

Juiciness value indicates the weight loss of cooked patty after a compression test. The test was measured following previously published method (Lucherk et al., 2017) with small modifications. Cooked patty was first cut into 1 cm² sample pieces, which was then covered with filter papers and pressed with a TA-4 probe (1-½″ diameter acrylic cylinder, 20 mm tall) for 30 seconds at 8 kg force using the Texture Analyzer (Stable Micro System, Godalming, Surrey, UK). The trigger force was set at 5 g, and the test speed was set at 0.5 mm/sec. Each patty treatment was tested in four replicates The percentage of juiciness was calculated according to the following equation:

$$Compressed juiciness ( \% ) = \frac{o r i ginal sample weight - sample weight after compression}{sample weight} \times 100$$

### 2.10 Descriptive Sensory Analysis

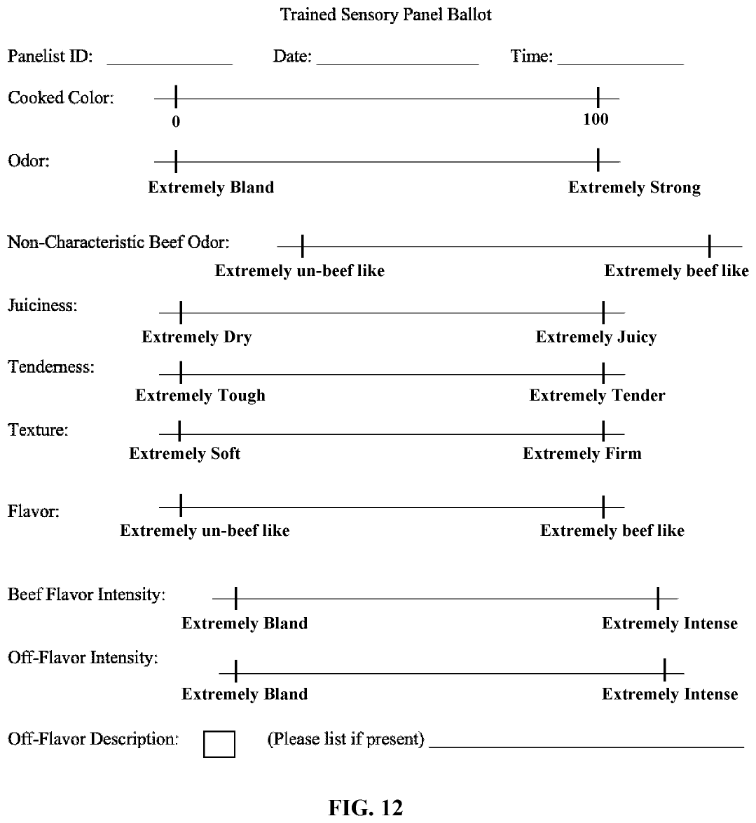

Beef patties for sensory analysis were prepared and served at the Kansas State University Meat Science lab. Ten different tubes of ground beef were purchased from a local grocery store, in order to prepare replication samples for each treatment. Beef patties were prepared by mixing ground beef (80% lean/20% fat) with pea proteins by hand and pressing into 0.25 lb patties using a patty maker, and the patties were then frozen, vacuum packed, and kept at −40° F. till further sensory analysis. The patties were thawed 12-24 hours before cooking, and the patties were grilled on a clamshell-style grill until reaching the internal temperature of 160° F. Each cooked patty was cut into six equally sized wedges, and each panelist was fed six samples (1 wedge/sample) in random order including the warm-up ones. Six well-trained panelists had additional three sections of training with the same patty samples before formal sensory evaluations. Each patty treatment was evaluated in ten replicates (i.e., ten different testing sections). Sensory attributes including juiciness, tenderness, beef flavor, beef flavor intensity, texture, and off-flavor were scored on a continuous 100-point line with a midpoint of 50 (FIG. 12).

### 2.11 Statistical Analysis

All the data were analyzed using SAS University Edition software (SAS Institute, Cary, NC, USA) based on one-way ANOVA and Tukey's post-hoc comparison test, and p<0.05 was considered as a significant difference among the data sets. The data were presented as mean±standard deviation. Principal Component Analysis (PCA) was conducted using XLSTAT 2021

(Addinsoft, New York, NY, USA) to determine associations among the different beef patty characteristics.

### 3. Results and Discussion

### 3.1 Functional Properties of Pea Proteins

The modified pea protein, i.e., PGG, showed significantly improved functional characteristics compared with the original pea protein isolate (PPI) (Table 6).

TABLE 6
Functional properties of pea protein isolate (PPI)
and functionally enhanced pea protein (PGG).

| | | | | | | Solubility |
|---|---|---|---|---|---|---|
| Samples | WHC (g/g) | OHC (g/g) | EC (%) | ES (%) | LGC (%) | (pH 7) (%) |
| PPI | 4.09 ± 0.02^{b} | 1.35 ± 0.04^{b} | 88.67 ± 0.44^{b} | 66.67 ± 0.63^{b} | 17%^{b} | 22.89 ± 0.47^{b} |
| PGG | 4.84 ± 0.04^{a} | 2.16 ± 0.09^{a} | 99.43 ± 0.12^{a} | 98.21 ± 0.26^{a} | 12%^{a} | 50.53 ± 0.50^{a} |

Note:
Water holding capacity (WHC), oil holding capacity (OHC), emulsion capacity (EC), emulsion stability (ES), least gelation capacity (LGC), and solubility.
*Means with different letters in each column indicate significant differences (p < 0.05).

The water and oil holding capacity (WHC, OHC) of PGG were 4.84 and 2.16 g, respectively, significantly higher (p<0.05) than that of PPI (WHC of 4.09 g and OHC of 1.35 g). The emulsion capacity and stability of PGG were greatly increased to 99.4 and 98.2%, respectively, compared with PPI (88.7 and 66.7%, respectively). The PGG also exhibited much better gelation capacity, with a least gelation concentration (LGC) of 12%, while the LGC of the PPI was 17%. Solubility of PGG was also twice of that of PPI at pH 7 (50.5 vs. 22.9%). After deamidation of pea protein with protein glutaminase, some of the glutamine residues were converted to glutamate residues, resulting in improved functional properties. Further inclusion of guar gum onto the protein structure through conjugation increased protein hydrophilicity, and the altered hydrophilicity/hydrophobicity balance favored protein-water interactions and improved protein dispersion stability. In addition, the inter-and intra-molecular interactions were partially disrupted and altered during the modifications, resulting in protein unfolding and structural rearrangement. These molecular changes favored many protein functional properties, leading to functionally enhanced pea protein ingredient, namely PGG in this study.

### 3.2 Physical Properties of Beef Patties Containing Pea Proteins

### 3.2.1 Color

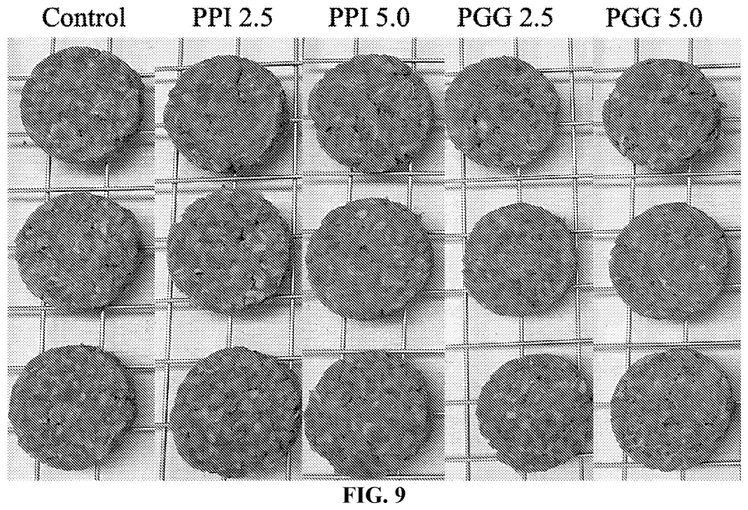

The pictures and color parameters, including L* (−black to +white), a* (−green to +red), and b* (−blue to +yellow), of raw beef patties are shown in FIG. 9 and Table 7, respectively.

TABLE 7
Color, cooking loss, moisture and fat retention of beef patties.

| | Color (raw patty) | | | Cooking | Moisture | Fat |
|---|---|---|---|---|---|---|
| | L* | a* | b* | loss (%) | retention (%) | retention (%) |
| Control | 46.42 ± 1.11^{a} | 17.09 ± 0.74^{a} | 18.29 ± 0.46^{a} | 32.82 ± 1.69^{a} | 91.57 ± 4.00^{b} | 83.05 ± 3.26^{ab} |
| 2.5% PPI | 44.83 ± 1.38^{b} | 17.13 ± 0.69^{a} | 18.44 ± 0.48^{a} | 30.54 ± 1.93^{a} | 97.56 ± 4.33^{ab} | 74.58 ± 1.64^{b} |
| 5% PPI | 46.17 ± 1.34^{ab} | 16.22 ± 0.92^{a} | 18.28 ± 0.56^{a} | 25.84 ± 2.50^{b} | 97.23 ± 1.81^{ab} | 74.92 ± 5.78^{b} |
| 2.5% PGG | 47.33 ± 0.61^{a} | 14.46 ± 0.71^{b} | 16.79 ± 0.81^{b} | 26.70 ± 2.80^{b} | 98.74 ± 3.27^{ab} | 78.19 ± 4.33^{b} |
| 5% PGG | 47.31 ± 1.27^{a} | 13.09 ± 0.74^{c} | 16.42 ± 0.78^{b} | 20.13 ± 2.12^{c} | 100.15 ± 0.36^{a} | 89.15 ± 1.95^{a} |

*Means with different letters in each column indicate significant differences (p < 0.05).

The patties containing PGG had significantly lower a* and b* values compared with the control and PPI patties, and a* value decreased with increased PGG addition (Table 7). This indicates that adding PGG decreased the redness of beef patties, while the effect of PPI on the redness was less obvious, which was attributed to the original color differences of PGG and PPI (Table 8, FIG. 8).

TABLE 8
Color of protein powders (PPI and PGG). *Means with different letters
in each column indicate significant differences (p < 0.05).

| | L* | a* | b* |
|---|---|---|---|
| PPI | 81.71 ± 0.02^{a} | 2.57 ± 0.02^{a} | 17.78 ± 0.01^{a} |
| PGG | 76.78 ± 0.02^{b} | 2.32 ± 0.02^{b} | 15.90 ± 0.01^{b} |

The patty with 5% PGG had the lowest a* value, because the concentration of myoglobin pigment was the most diluted. Others reported that the L* value decreased from 61.44 to 58.16 when protein content was increased in the cooked meat batters; however, the L* value was also dependent on other factors, such as protein content/types and oil types.

### 3.2.2 Cooking Loss

Cooking of meat causes protein denaturation and shrinkage of myofibrillar and collagen proteins. The loss during cooking include liquid drippings and volatile losses. Cooking loss determines cooking yield, and it is highly related to the sensory properties of meat products, in particular juiciness, tenderness, and other important quality attributes. The beef patties containing 5% PPI, 2.5% and 5% PGG had significantly decreased cooking loss compared with the control (32.8%) and 2.5% PPI patty (30.5%) (Table 7). As protein addition increased from 2.5 to 5%, the cooking loss was significantly decreased (p<0.05) for both PPI and PGG based patties. This is because the plant proteins with good water and oil holding capacities and surface activity can form adhesive gel matrix in the patties and can better stabilize the meat emulsions when at a higher concentration. The proteins may also act as fat-encapsulating agent to prevent oil dripping during cooking. However, others reported that when the amount of meat proteins in beef batter emulsions with canola oil increased from 8 to 15%, the cooking loss was increased. This might because the proteins formed a denser and aggregated network, which led to coalesce and migration of fat globules out of the protein matrix. Therefore, the amount and type of protein added to meat systems is an important factor affecting cooking loss and final textural properties.

In addition, the meat patties containing PGG had significantly decreased cooking loss (26.7% at 2.5% protein and 20.1% at 5% protein) when compared with PPI patties (30.5% at 2.5% protein and 25.8% at 5% protein) at the same protein addition level. The result implied that the functionally enhanced pea protein (PGG) with greater functional properties (e.g., water/oil holding capacity, emulsifying properties, gelation) can improve the cooking yield of meat patties compared to the original pea protein.

### 3.2.3 Moisture and Fat Retention

Moisture and fat retentions indicate the capacity of beef patty in holding the original water and fat after cooking. They are related to cooking loss and textural and sensory attributes of cooked patties, such as juiciness. The addition of PPI and PGG increased moisture retention of patties, though the values were not significantly (p>0.05) different compared with the control (91.57%), while the beef patty with 5 PGG had significantly higher (p<0.05) fat retention (89.15%) compared with the control (83.05%) and other patty treatments (Table 7). The increased water retention is because the added pulse proteins can better absorb and hold water by forming gel matrix during heating, and the plant protein may also interact with meat proteins in forming complex three-dimensional gel network that can better trap the water, resulting in firmer and more compact structures. In addition, due to the higher oil holding capacity of PGG compared with PPI, the beef patty with 5% PGG had significantly increased fat retention. The largest fat and moisture retention values of 5% PGG patty may also partially explain its lowest cooking loss among all the treatments.

### 3.2.4 Texture Profile Analysis

With the addition of PPI or PGG, the beef patties showed different texture profiles such as hardness, resilience, springiness, and chewiness (Table 9).

TABLE 9
Physical attributes of beef patties from instrument analysis.

| | | Resilience | | Springiness | | | Compressed |
|---|---|---|---|---|---|---|---|
| | Hardness (g) | (%) | Cohesiveness | (%) | Chewiness (g) | Shear force (g) | juiciness (%) |
| Control | 5643.5 ± 607.1^{b} | 19.9 ± 1.2^{a} | 0.5 ± 0.0^{a} | 81.7 ± 1.4^{a} | 2365.5 ± 428.0^{ab} | 1429.0 ± 133.5^{a} | 19.1 ± 2.1^{a} |
| 2.5% | 7061.8 ± 425.0^{a} | 20.5 ± 0.7^{a} | 0.5 ± 0.0^{a} | 81.6 ± 1.0^{a} | 3006.3 ± 281.7^{a} | 1344.7 ± 190.8^{ab} | 13.7 ± 1.9^{bc} |
| PPI | | | | | | | |
| 5% PPI | 7359.2 ± 323.0^{a} | 19.6 ± 1.0^{a} | 0.5 ± 0.0^{a} | 81.8 ± 1.7^{a} | 3081.3 ± 237.6^{a} | 1906.9 ± 92.1^{a} | 16.0 ± 0.8^{ab} |
| 2.5% | 4889.8 ± 328.0^{bc} | 18.2 ± 1.2^{b} | 0.5 ± 0.0^{a} | 78.3 ± 3.6^{a} | 1856.1 ± 244.1^{bc} | 1379.8 ± 360.3^{ab} | 15.5 ± 1.3^{b} |
| PGG | | | | | | | |
| 5% | 3984.1 ± 459.1^{c} | 15.7 ± 1.4^{b} | 0.4 ± 0.0^{b} | 71.9 ± 2.2^{b} | 1197.4 ± 155.1^{c} | 831.7 ± 142.1^{b} | 11.9 ± 0.6^{c} |
| PGG | | | | | | | |

*Means with different letters in each column indicate significant differences (p < 0.05).

For example, adding PPI significantly increased patty hardness (up to 7359 g with 5% PPI), while adding PGG significantly (p<0.05) decreased patty hardness (as low as 3984 g with 5% PGG), compared with the control patty (5643 g). When the concentration of PGG increased from 2.5 to 5%, the cohesiveness and springiness also significantly decreased. During cooking of the patties, heat-induced gelation of myofibrillar proteins is critical to deliver product integrity and needed texture and sensory properties. The increased hardness of patties with the original PPI may be caused by the alteration of binding blocks among meat pieces and gel formation in the system from interactions among the meat and non-meat proteins. Similar results were found in beef patties with pea protein and emulsified meat batters with soy protein. Others reported that pork burger with 3% soy protein isolate (SPI) had significantly decreased hardness compared with the control (no SPI addition), but this may be attributed to the softer texture of hydrated SPI since water addition was increased in the patties based on different concentrations of SPI. On the other side, adding PGG greatly decreased the hardness of patties. As discussed previously, PGG possessed stronger water and oil holding capacities and gelation and emulsifying properties than PPI (Table 6), and the resultant patties also showed higher moisture and fat retention values (Table 7), which may partially contribute to the softer texture. In addition, modification (sequential deamidation and conjugation) of PPI in producing PGG changed protein secondary conformation and surface hydrophobicity (data not shown), which might weaken the binding and interactions among meat pieces compared to the original PPI. The raw PGG patties were much softer compared with the PPI and original beef patties. Further, the higher emulsifying potential of PGG may lead to more stable emulsions in the patties. Some have found that the hardness of meat was associated with the destabilization of emulsion, which can be caused by the separation of fat and water. Besides, guar gum has a softening effect when it is added to meat product. Others reported that low-fat meatballs showed decreased hardness and cohesiveness when guar gum was added at 0.5 and 1%. For the PGG patties, although a very low amount of guar gum was used during conjugation (i.e., PGG was prepared with 5% guar gum based on PPI, corresponding to 0.025% gum addition in patties containing 5% PGG), it may still partially contribute to the softer texture of the patties.

### 3.2.5 Shear Force

The Warner-Bratzler shear force indicates the maximum force as a knife cutting through meat sample, and it is useful for assessing meat tenderness. With 2.5% PPI or PGG, the patties showed similar shear force as the control. When PPI addition was increased to 5%, the shear force of the patty was greatly increased to 1909 g; while the patty with a higher amount of PGG (5%) had significantly decreased shear force of 832 g, compared with the control patty (1429 g) (Table 9). Some indicated that non-meat protein can be alternative gelling agent, which enhances the binding of meat pieces, thus resulting in increased shear force of the patties with a higher amount of PPI. The decreased shear force of the patty with 5% PGG may be attributed to the better water and oil holding capacities of PGG protein, which can retain more moisture and fat in the cooked patties (Tables 6 and 7). The shear force of patties had a similar trend as the hardness values. Some have reported that addition of tapioca starch and sorghum flour decreased shear force of chicken breast meat patties and beef patties, respectively. However, other studies also reported that the non-meat proteins increased hardness and shear force of meat products. It can be concluded that both protein concentration and functional properties of the added plant ingredients (e.g., flour, starch, protein) influence the meat texture.

### 3.2.6 Compressed Juiciness

Compressed juiciness values of the beef patties are summarized in Table 9. Overall, adding either PPI or PGG proteins decreased the values of compressed juiciness (ranging from 11.9-16.0%) compared with the control patty (19.1%). The beef patty with 5% PGG exhibited the lowest compressed juiciness value (11.9%). This is because the plant proteins (PPI or PGG) with good water and oil holding capacities and gelation properties can effectively bind water and oil in the beef patties and form gel matrix. Thus, the water and oil could not be easily extruded from the meaty matrix when the patty was compressed during testing, resulting in higher amount of residue moisture and oil in the patties with added proteins compared with the control. Some reported that adding texturized soy protein also decreased goat patty juiciness, and it was attributed to the better water absorption and holding capacity of the texturized proteins. They also showed that the juiciness was increased by increasing the content of liquid whole eggs in the patty formulation. Others reported that the compressed juiciness of beef meatballs was not affected by adding whey protein of up to 4%, but decreased when the fat content was increased from 5 to 20%, which was related to the moisture and fat retention capacity of the meat balls. Overall, ingredient functionality, product formulation, and processing methods all determine the cookability and instrumental juiciness values of the product.

### 3.3 Descriptive Sensory Properties and Principal Component Analysis (PCA)

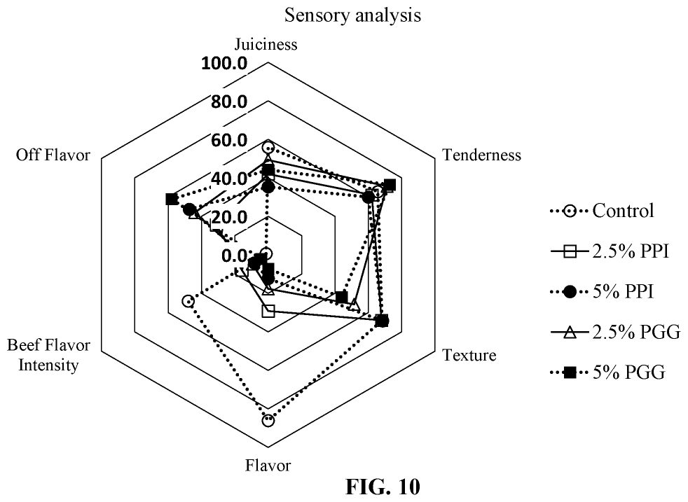

Descriptive sensory characteristics of beef patties in terms of juiciness, tenderness, texture, beef flavor, beef flavor intensity, and off-flavor are presented in FIG. 10 and summarized in Table 10 (Supplementary Documents).

TABLE 10
Descriptive sensory scores of beef patties with PPI or PGG.

| | | | | | Beef | |
|---|---|---|---|---|---|---|
| | | Tender- | | | flavor | Off |
| | Juiciness | ness | Texture | Flavor | intensity | flavor |
| Control | 55.9^{a} | 65.7^{b} | 68.2^{a} | 86.1^{a} | 48.1^{a} | 1.3^{d} |
| 2.5% PPI | 42.0^{cd} | 62.1^{bc} | 67.9^{a} | 29.2^{b} | 15.8^{b} | 31.1^{c} |
| 5% PPI | 35.3^{d} | 60.0^{c} | 68.5^{a} | 12.3^{cd} | 8.4^{c} | 47.2^{b} |
| 2.5% PGG | 49.3^{ab} | 71.2^{a} | 51.5^{b} | 17.6^{c} | 9.5^{c} | 44.0^{b} |
| 5% PGG | 44.2^{bc} | 72.9^{a} | 43.9^{c} | 7.3^{d} | 4.2^{c} | 57.8^{a} |

*Means with different letters in each column indicate significant differences (p < 0.05).

Overall, the beef patties containing PPI or PGG (both 2.5 and 5%) showed significantly (p<0.05) decreased juiciness, beef flavor, and beef flavor intensity, but increased off-flavor compared to the control. However, tenderness of the beef patties containing PGG significantly increased (p<0.05) to around 72% for both 2.5 and 5% PGG patties, and the texture decreased to 51.5% for 2.5% PGG patty and 43.9% for 5% PGG patty, compared with the control patty (65.7% tenderness and 68.2% texture). These sensory results agreed with the decreased hardness and chewiness of PGG patties from physical texture measurement (Table 9). Although juiciness was decreased for patties with the plant proteins compared with the control, PGG patties still showed significantly higher juiciness than PPI patties when protein was added at the same level, which was attributed to the better functional properties (water/oil holding capacity, emulsification, gelation) of PGG than PPI. The results implied that some of the functional properties of plant protein ingredients can be carried over into end food products, such as in beef patties.

The highest sensory juiciness score for the control patty was also in agreement with its largest compressed juiciness data from instrument measurement. However, the trend was somewhat different when comparing the compressed juiciness with sensory juiciness score for the patties containing added proteins. For example, the juiciness score of 5% PGG patty (44.2%) was much higher than that of 5% PPI patty (35.3%), but the former had a lower compressed juiciness value (11.9%) than the latter (16.0%). This is because sensory juiciness is mostly attributed to the available fats on the surface or crevice of patties perceived by the panelists during chewing, and it can also be associated to the tenderness and texture of patties, while compressed juiciness is determined by the liquid (oil/water) holding capacity of cooked patties. In addition, beef flavor and flavor intensity of the patties were greatly reduced, and off flavor was significantly increased even with only 2.5% plant protein addition. However, the beef patties containing PGG still demonstrated some advantages over the control patty, such as higher fat/water retention and cooking yield and softer and tender texture, which may be preferred by some elders. The flavor defect may be partially overcome by serving the patties with seasonings and dressings during meal service.

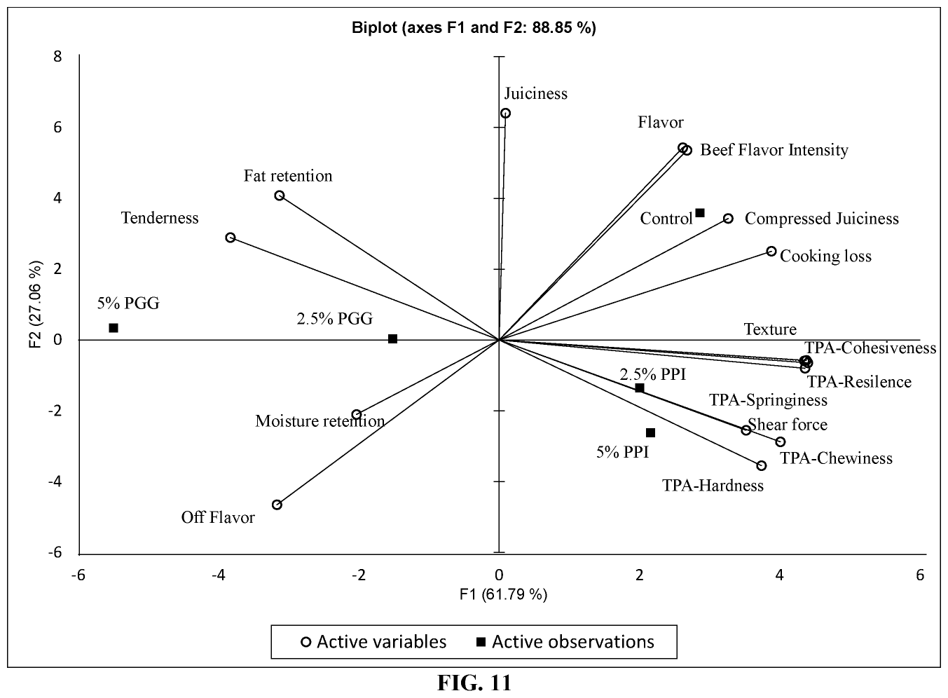

Principal component analysis was conducted to further determine the relationship between physical properties and sensory attributes of the different patty treatments (FIG. 11). The eigenvalues 1 and 2 represented 87.85% of the variability. As shown on the biplot, the control beef patty without any plant protein addition was associated with strong beef flavor, high flavor score, large compressed juiciness value, and high cooking loss. The beef patties containing PPI (either 2.5 or 5%) were associated with high hardness, chewiness, and shear force value, while the beef patties with PGG were associated with better moisture and fat retention, lower cooking loss, softer texture, and tender sensory. All the beef patties containing the added proteins were also associated with off-flavor, which is common for many plant proteins.

### 4. Conclusions

Sequential modification of pea protein isolate (PPI) through deamidation and conjugation produced functionally enhanced protein, named PGG, with greater water and oil holding capacities, emulsifying properties, solubility, and gelation properties. Some of these functional properties in the protein ingredient can be carried over into end food products, such as in cooked patties. Extending beef patties with PPI or PGG reduced cooking loss, and thus increasing cooking yield, but also led to decreased juiciness and beef flavor scores and increased off-flavor score. The beef patties containing PGG also showed much softer and tender texture compared with the control patty, which would be advantageous features for some elders with such sensory preference. Further research is needed to eliminate or reduce the off flavor in patties and other meat products extended with plant proteins.

### Example 3

### Improving Functional Properties of Pea Protein Through “Green” Modifications Using Enzymes and Polysaccharides

This Example demonstrates the modification procedures and enhanced properties of the modified proteins, compared with unmodified protein.

### Abstract

Pea proteins have gained significant interest in recent years. The objective of this study was to enhance pea protein functional properties through enzymatic and/or conjugation modifications and understand the physicochemical properties of the modified proteins. Molecular changes of the proteins were characterized, and protein functionality, in vitro digestibility, and sensory properties were analyzed. The proteins crosslinked with transglutaminase showed significantly improved water holding capacity (5.2-5.6 g/g protein) compared with the control pea protein isolate (2.8 g/g). The pea proteins conjugated with guar gum showed exceptional emulsifying capacity (EC) and stability (ES) of up to 100% compared with the control protein (EC of 58% and ES of 48%). Some sequentially modified pea proteins, such as transglutaminase crosslinking followed by guar gum conjugation had multiple functional enhancement (water holding, oil holding, emulsifying, and gelation). The functionally enhanced pea proteins had comparable sensory scores as the control protein.

### 1. Introduction

The demand for food proteins is continually increasing worldwide, due to the rapid growth of global population and needs for healthy and nutritious diets. Proteins are the essential building blocks and dietary macronutrients for human body. In addition to the nutritional value, protein ingredients deliver crucial techno-functional properties that contribute to food quality and sensory characteristics. In recent years, plant proteins have attracted more attention from consumers because of their lower cost, energy efficiency, and environmental sustainability compared with animal proteins.

Pea protein is one of the most used plant proteins, after wheat gluten and soy proteins. It contains high levels of lysine, threonine, and tryptophan and has good digestibility, non-transgenicity, and low allergenicity. However, the commercial utilization of pea protein is still relatively limited, owing to its less desirable functional characteristics in some applications and beany flavor, which may be improved through physical, chemical, or enzymatic modifications. When pea protein suspension with higher concentration was served, people could feel the gritty texture, and lumps could get adhere to throat during swallowing.

Enzymatic deamidation using protein glutaminase was reported to modify pea proteins, which converts some amide groups (glutamine or asparagine) to carboxyl groups (glutamic acid or aspartic acid). The deamidation modification increased the concentration of negatively charged carboxyl group and exposed some hydrophobic side chains of the protein, which shifted the isoelectric point to the acidic side. Some protein functional properties, such as solubility, foaming capacity, and emulsifying stability were improved through the enzymatic deamidation under appropriate conditions. Previous studies reported that the enzymatic deamidation enhanced protein solubility in wheat gluten, zein, and oat proteins. Sensory profiles affected included enhanced umami and reduced bitter flavor in deamidated wheat gluten, and reduced beany taste and lumpiness in deamidated pea protein. Transglutaminase is another enzyme commonly used to modify food proteins, and it catalyzes the covalent crosslinking between amino group on lysine residues and carboxyamide group on glutamine residues in protein. This modification can convert some soluble proteins to insoluble higher molecular weight polymers through inter- and intra-molecular interactions. In addition, many studies reported that pea protein modified by transglutaminase had enhanced gelation property.

Protein-polysaccharide conjugation is another green approach to modify the protein through glycosylation reaction between the carbonyl groups of polysaccharide and amine groups of protein. The conjugation modification enhances protein hydrophilicity and affects the balance of protein hydrophilicity and hydrophobicity. The modified protein may have more favored protein-water interaction, resulting in some improved functional properties, for example, emulsification property. Pea proteins conjugated with pectin, gum arabic, and soybean polysaccharide showed improved emulsifying, foaming properties, solubility, and thermal stability. Previously, we investigated the effect of acylation or/and conjugation on pea protein functionalities, and we found that the sequential acylation and conjugation modifications had exceptional synergistic and positive effects on protein emulsification, oil holding capacity, and gelation properties. Because of the concerns of using synthetic chemicals such as acetic anhydride or succinic anhydride during acylation modification, the aim of this study was to develop greener approaches based on enzymes and natural polysaccharides for protein functional enhancement. Although some previous studies have reported the functional improvement of plant proteins through enzymatic or conjugation modification alone with different enzymes or polysaccharides, combining both modifications may deliver some synergistic effects and produce more functional protein ingredients. Therefore, the objective of this study was to enhance the functional properties of pea protein through sequential enzymatic modification and polysaccharides conjugation, in comparison with enzymatic modification or polysaccharide conjugation alone, and understand the physicochemical and sensory properties of the modified proteins. The new modification methods have many advantageous natures, such as clean-label, mild reaction, safety, and efficiency. The newly modified and functionally enhanced pea proteins will further expand the uses of plant proteins in broader food applications and better meet the increasing protein demands.

### 2. Materials and Methods

### 2.1 Materials

Yellow pea flour was obtained from a commercial source. Guar gum (Judee's, Plain City, OH, USA), gum arabic (Fisher Scientific, Hampton, NH, USA), protein-glutaminase (Amano Enzyme Inc, Nagoya, Japan), and transglutaminase (Modernist pantry, Eliot, ME, USA) were used as received. Other chemicals were purchased from Sigma-Aldrich (St. Louis, MO, USA).

### 2.2 Preparation of Pea Protein Isolate

The yellow pea flour was first defatted with hexane. The defatted yellow pea flour was dispersed in distilled water at a 10% solid concentration. The pH was adjusted to 8.5 using 1.0 M NaOH, and the slurry was mixed at 500 rpm for 1 hour at room temperature. Then, the slurry was centrifuged at 8000 xg for 20 min at 4° C. The supernatant was collected, and pH was adjusted to 4.5 using 1.0 M HC1, which was then allowed to precipitate the protein at 4° C. for 2 hours. After that, the protein was recovered by centrifugation (8000 xg, 20 min), washed twice using distilled water, and re-adjusted to pH 7.0. Finally, the protein suspension was lyophilized and stored at 4° C. for further study.

### Preparation of Modified Pea Proteins

Enzymatically modified pea proteins were prepared by reacting the protein (10% concentration in water) with 1% transglutaminase at 40° C. or 1% protein-glutaminase (pH 6.5) at 55° C. for 3 hours, respectively. At the end of the reaction, the protein slurry was heated to 100° C. to inactivate the enzyme. Conjugated pea proteins were prepared by incubating the protein (10% concentration in water) with 5% guar gum or gum arabic (protein basis) at 60° C. for 24 hours. Enzyme treated/polysaccharide conjugated proteins were also prepared to investigate their synergistic effects, where after the deactivation of the enzyme, the protein slurry was added with guar gum/gum arabic (5%, protein basis) at 60° C. for 24 hours. The slurries of modified proteins were lyophilized and stored at 4° C. till further analysis.

### 2.3 Functional Properties

Protein functional properties, including solubility, emulsifying properties, water and oil holding capacities, and least gelation capacity were determined using our previous methods without modification.

### 2.4 Physicochemical Properties and In Vitro Gastrointestinal Digestibility

Protein physicochemical properties, including free sulfhydryl group content, free amino group content, protein secondary structures, surface hydrophobicity, and in vitro gastrointestinal digestibility were determined following previous methods without any modification.

Size exclusion chromatography (SEC-HPLC) was conducted to estimate molecular size changes of pea proteins with different modifications. The protein sample (1 mg/mL) was dispersed in sodium phosphate buffer (pH 6.8). The suspension was vortexed and vigorously mixed for 1 hr to dissolve the protein, followed by centrifugation at 4000×g for 5 min. The supernatant was collected and filtered through a 0.45 μm filter (Biomed Scientific, Forest, VA, USA). The protein separation was achieved using a Phenomenex SEC-4000 column (7.8×300 mm) at 30° C. with Agilent 1100 HPLC system (Santa Clara, CA, USA). The mobile phase included phase A (water with 0.1% trifluoroacetic acid) and phase B (acetonitrile), with gradient elution of 20% phase B at 0-20 min, 30% phase B at 20-25 min, 35% phase B at 25-40 min, and 20% phase B again at 40 min to elute all the residues. Flow rate was set at 0.7 mL/min. Proteins were detected at 214 nm using a diode array detector (Agilent, Santa Clara, CA, USA).

### 2.5 Sensory Analysis

Descriptive sensory analysis of pea and the modified pea proteins was conducted by six well-trained panelists to determine the flavor characteristics, including beany, starchy, grain, green, powdery mouthfeel, umami, sweet, astringent, bitter, and metallic flavors. The descriptive analysis was conducted using an intensity scale with 0.5 increments (0 =none; 15 =extremely intense). For each protein sample, 1.2 g protein was dispersed in 30 mL distilled water to obtain an aqueous dispersion of 4%. The protein dispersion was placed in a transparent cup with a lid labeled with a randomly selected three-digit code. Before being served, the panelists manually remixed the suspension to achieve a homogenous dispersion. Pure water, unsalted crackers, and mozzarella cheese were used for mouth rinsing between samples to avoid any carry-over effect. The panelists completed one 1 h orientation session in order to align on the attributes and reference materials and three 1 h evaluation sessions. The evaluation was completed based on a modified flavor profile approach using consensus. The references and definitions of flavor attributes used for this study were provided in the Supplementary Document. The sensory analysis was approved by the KSU Institutional Review Board committee, IRB-5930.

### 2.6 Statistical Analysis

All the tests were conducted in at least duplicates, and the results were presented as mean±standard deviation (SD). All the results were evaluated by one-way ANOVA, and Tukey's post-hoc test was conducted using SAS University Edition software (SAS Institute, Cary, NC, USA) to assess the significant differences (p<0.05) among different treatments.

### 3 Results and Discussion

### 3.1 Free Sulfhydryl Group and Free Amino Group

The free sulfhydryl (SH) content of the control and modified pea proteins is summarized in Table 11.

TABLE 11
Physicochemical properties including free sulfhydryl group content, free amino
group content, secondary structures of pea and modified pea proteins.

| | Free SH | Free NH₂ | | | | Random | Hydrophobicity |
|---|---|---|---|---|---|---|---|
| Samples | (μmol/g) | (mmol/g) | α-Helix (%) | β-Sheet(%) | β-Turn (%) | coil (%) | (H0) |
| Control | 13.52 ± 0.09^{a} | 8.44 ± 0.06^{a} | 18.64 ± 0.09^{cd} | 27.52 ± 4.37^{bc} | 11.48 ± 2.27^{bc} | 42.37 ± 6.55^{a} | 202,096 ± 12,306^{b} |
| PG | 9.91 ± 0.06^{c} | 7.53 ± 0.13^{b} | 53.72 ± 0.48^{a} | 26.67 ± 2.96^{bc} | 19.61 ± 2.48^{a} | ND | 161,826 ± 1,274^{a} |
| TG | 11.86 ± 0.08^{b} | 5.30 ± 0.06^{c} | 21.97 ± 1.60^{c} | 60.69 ± 3.30^{a} | 17.33 ± 1.70^{ab} | ND | 73,910 ± 1,500^{f} |
| Guar | 7.68 ± 0.02^{d} | 7.31 ± 0.16^{b} | 37.62 ± 1.56^{b} | 52.54 ± 0.78^{a} | 9.84 ± 0.77^{cd} | ND | 93,342 ± 1,099^{e} |
| Arabic | 6.46 ± 0.03^{ef} | 7.56 ± 0.22^{b} | 41.20 ± 10.39^{ab} | 48.08 ± 9.75^{ab} | 10.71 ± 0.64^{cd} | ND | 105,724 ± 1,995^{e} |
| PG-Guar | 5.61 ± 0.00^{g} | 7.34 ± 0.29^{b} | 9.66 ± 0.38^{cd} | 47.96 ± 1.33^{ab} | 6.88 ± 0.10^{cd} | 35.51 ± 1.05^{a} | 186,742 ± 3,243^{c} |
| PG-Arabic | 4.89 ± 0.04^{h} | 7.41 ± 0.22^{b} | 7.39 ± 1.02^{d} | 58.92 ± 1.72^{a} | 4.85 ± 0.28^{d} | 28.84 ± 2.46^{a} | 230,281 ± 1,223^{a} |
| TG-Guar | 6.68 ± 0.04^{e} | 5.39 ± 0.06^{c} | 10.29 ± 2.14^{cd} | 56.58 ± 12.13^{a} | 6.05 ± 0.80^{cd} | 27.08 ± 15.06^{a} | 28,158 ± 1,846^{g} |
| TG- | 6.28 ± 0.15^{f} | 5.19 ± 0.10^{c} | 20.90 ± 0.54^{cd} | 22.33 ± 4.19^{c} | 8.86 ± 2.34^{cd} | 47.91 ± 5.99^{a} | 22,563 ± 1,098^{g} |
| Arabic | | | | | | | |

*Means with different letters in each column indicate significant differences (p < 0.05).
** ND: not detected.

The enzymatically modified and/or conjugated pea proteins showed significantly reduced free SH content than the control pea protein (13.5 μmol/g). The pea protein deamidated by PG, crosslinked by TG, and conjugated with guar gum or gum arabic all had decreased free SH group, which was attributed to the fact that the mechanical mixing in air condition during the modification processes favored the oxidation reaction by converting some free SH groups to disulfide bonds. The conjugated proteins exhibited significantly lower free SH group content than the enzymatically modified proteins, which was ascribed to the higher reaction temperature during the conjugation than the deamidation and crosslinking reactions; thus, more disulfide linkages were formed. The sequentially modified proteins exhibited even lower free SH group content than the proteins from deamidation or crosslinking reaction alone, which is because the former proteins underwent heat treatments twice during the combined modifications.

Free amino group content indicates the degree of enzymatic and conjugated modifications in the modified pea proteins, as the amino group was a major reaction site during the modifications. Overall, all the modified pea proteins showed significantly (p<0.05) lower content of free amino group compared with the control protein (8.44 mmol/g) (Table 11). The pea protein crosslinked by transglutaminase and/or conjugated with guar gum or gum arabic exhibited the lowest free amino group content, which was attributed to formation of ϵ-(γ-Glu)-Lys polymers with the free aminos. The decreased free amino group in deamidated proteins occurred because the conversion of amide groups to carboxyl groups in the presence of protein glutaminase, as ammonia was formed, and free amino group content was reduced. The reduced free amino group in the proteins conjugated with gums was due to the Maillard reaction that consumed some amino groups.

### 3.2 Protein Secondary Structures

The control pea protein consisted of 18.64% α-helix, 27.52% β-sheet, 11.48% β-turn, and 42.37% random coil (Table 11). With different modifications, the secondary structure composition was greatly changed. For example, the proteins modified by PG, TG, guar gum, and gum arabic did not have any random coils, while the proteins modified by TG, guar gum, and gum arabic had greatly increased α-helix and β-sheet, and the protein modified by PG and TG had increased β-turn, compared with the control. However, the sequential enzymatic and conjugated modifications increased the random coil, reduced β-turn, and slightly reduced α-helix contents (in PG-Guar and PG-Arabic) compared with the enzymatic or conjugated protein alone. These results demonstrated that the enzymatic or conjugated modifications enabled the protein to be unfolded, and some random structures could be converted to more regular and ordered structures. Some have reported that α-helix content was increased in deamidated oat protein compared with the control because of increased flexibility protein molecules. Further, they observed that β-sheet was decreased with higher degree of protein deamidation. Others have reported that both β-sheet and random coil were increased in TG crosslinked zein. Therefore, it can be concluded that secondary structure composition of modified proteins was affected by the nature of the modification, degree of modification, enzyme and protein types, and extent of non-covalent interactions.

### 3.3 Surface Hydrophobicity

Protein surface hydrophobicity was measured to estimate the availability of nonpolar amino acid residues exposed to the surface of the protein. Overall, the enzyme modified and/or conjugated pea proteins showed significantly decreased surface hydrophobicity compared with the control, except for the PG-Arabic (Table 11). The decreased surface hydrophobicity for the protein deamidated by PG might be because the deamidation modification increased carboxylic acid residues and favored hydrophobic interactions of the protein. Prior reports have shown that deamidated whey protein by protein glutaminase had decreased surface hydrophobicity. However, some other studies reported increased surface hydrophobicity for deamidated proteins, such as barley hordein, wheat gluten, and zein. Surface hydrophobicity of deamidated proteins are affected by many factors, such as protein type and original hydrophobicity/hydrophilicity, enzyme concentration, and other reaction parameters. The proteins crosslinked by transglutaminase (e.g., TG, TG-Guar, TG-Arabic) showed dramatically decreased surface hydrophobicity compared with the control and other modified proteins, which was attributed to the aggregated proteins formed during crosslinking and partial burial of the hydrophobic cavities in the protein core, thus reducing protein surface hydrophobicity. Some have indicated that freeze-dried quinoa protein had higher surface hydrophobicity than spray-dried protein, which was attributed to the extent of protein denaturation during the different drying processes.

### 3.4 SEC-HPLC

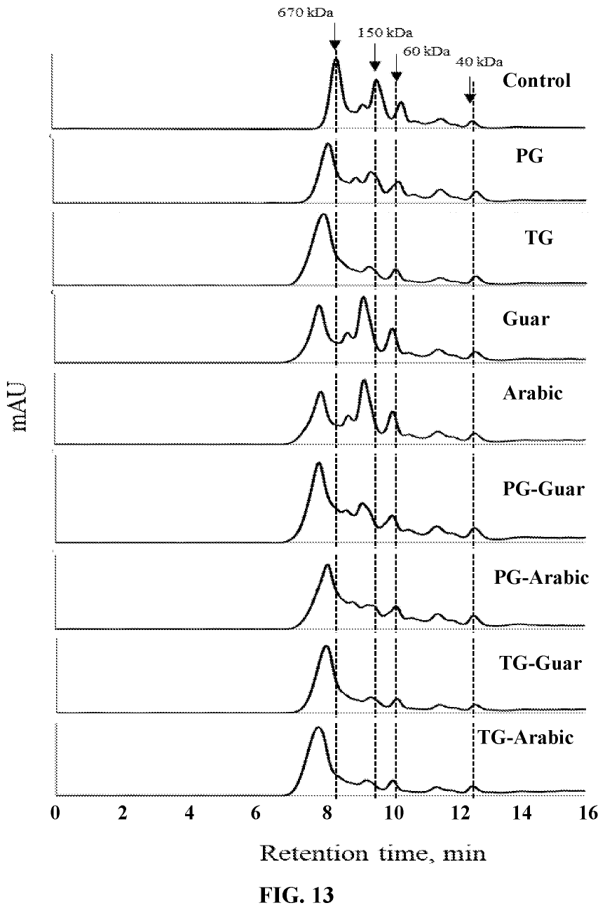

Four proteins with known molecular sizes, including thyroglobulin bovine (670 kDa), γ-globulins from bovine blood (150 kDa), bovine serum albumin (60 kDa), and chicken egg grade VI albumin (44 kDa), were separated with the same chromatography conditions and marked on the chromatogram as molecular weight references (FIG. 13). With enzymatic modification and/or conjugation with polysaccharides, some proteins with larger molecular sizes were formed compared to those in the control pea protein, as indicated by the left shift of the first peak (670 kDa) on the chromatograms. The modified pea proteins from conjugation alone (e.g., Guar, Arabic) had similar peak patterns as the control one, except that the peak size between 150-670 kDa was increased, while the peak around 670 kDa was relatively decreased, which was caused by the alteration of the sizes of medium molecule proteins during conjugation. For all the modified proteins involving enzymatic treatment, there was a dramatic decrease of peak sizes in the range of 60 to 150 kDa, which was caused by the formation of larger proteins (670 kDa) through various crosslinking mechanisms. The mechanical mixing during the enzymatic and conjugation modifications along with increased temperature favored the oxidation reaction to induce protein crosslinking. The PG and TG protein samples underwent enzyme deactivation (i.e., boiling the protein slurries at 100° C. for min) after protein deamidation and crosslinking reactions, which also favored protein crosslinking, in addition to the enzymatically induced crosslinking reactions. Furthermore, the sequential enzymatic and conjugated proteins exhibited even larger molecular size, especially for the TG-Guar and TG-Arabic samples. Several peaks disappeared, and some small peaks were merged into one prominent peak, similar to the sample TG. This SEC-HPLC result can be associated with the free sulfhydryl content (Table 11) and confirmed that the modified pea protein had exhibited a larger molecular size partially due to the protein crosslinking reaction.

### 3.5 Solubility

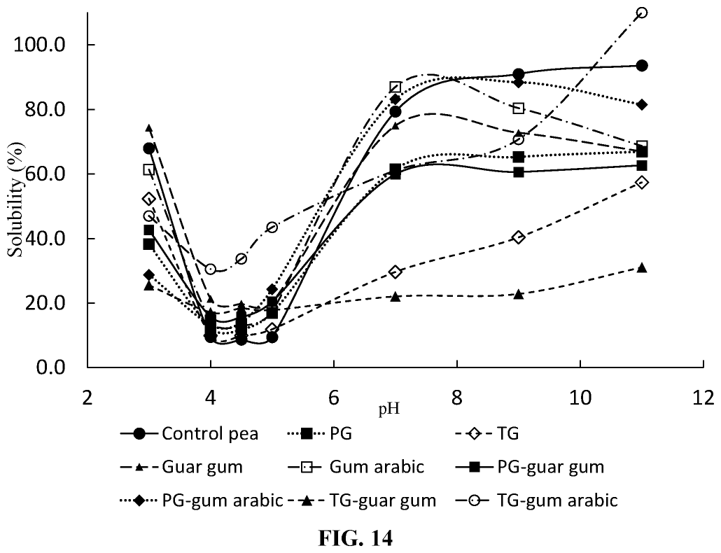

The control pea protein, which was extracted from pea flour in the lab and lyophilized, exhibited great solubility when the pH was away from the isoelectric point (PI, pH 4-5). The solubility was also much better than commercial pea protein, which implied that the commercial processing conditions of the proteins might cause more intensive structural denaturation that impaired the solubility. With the enzymatic and/or conjugation modifications, most of the modified pea protein had similar or decreased solubility than the control pea protein when the pH was away from the PI, while the modified pea proteins had slightly increased solubility at the PI (FIG. 14). Some of the pea proteins crosslinked with transglutaminase (e.g., TG, TG-Guar) were the least soluble at pH above the PI compared with the other modified protein samples. Pea protein contains high amount of lysine, and it favors the crosslinking reaction catalyzed by transglutaminase. This reaction enabled the formation of larger protein polymers, which became less soluble. Notably, the protein sample treated with TG and gum arabic had much greater solubility at PI and pH 11 compared with the control and TG and TG-Guar proteins, which may be attributed to the synergistic effects of transglutaminase and gum arabic modifications. Some have reported that commercial pea protein conjugated with gum arabic showed significantly improved solubility, because the less soluble 11S and 7S subunits of pea protein and hydrophilic gum arabic were involved in forming conjugates, which improved the overall solubility. Our earlier work above also reported a similar finding showing improved solubility for commercial pea protein isolate conjugated with guar gum. Even for the lab extracted protein, our results showed that pea protein conjugated with gum arabic or treated with PG-Arabic had slightly increased solubility at pH 4.5-7 compared with the control and other treatments. Previous studies reported that enzymatic deamidation improved the solubility of gluten proteins and zein proteins, because the induction of additional carboxyl groups to the protein molecules provided a newly balanced amphiphilicity that favored protein interaction with water. As for some of our modified pea proteins from deamidation and/or conjugation, the solubility was not improved, which was because the native structure of the control pea protein was more favorable to solubility, compared to the denatured and modified structures.

### 3.6 Water and Oil Holding Capacity

Overall, the proteins treated by transglutaminase, for example, TG, TG-Guar, and TG-Arabic, had significantly higher water holding capacities of 5.31, 5.62, and 5.21 g water /g protein, respectively, compared with the control pea protein (2.66 g/g) (Table 12).

TABLE 12
Functional properties including water holding capacity (WHC), oil holding
capacity (OHC), emulsion capacity (EC), emulsion stability (ES), and least
gelation capacity (LGC) of pea and modified pea proteins. *Means with different
letters for each column indicate significant differences (p < 0.05).

| Samples | WHC (g/g) | OHC (g/g) | EC (%) | ES (%) | LGC (%) |
|---|---|---|---|---|---|
| Control | 2.66 ± 0.06^{f} | 2.76 ± 0.05^{c} | 58.58 ± 2.21^{c} | 48.14 ± 1.77^{d} | 11^{d} |
| PG | 3.62 ± 0.04^{d} | 2.68 ± 0.08^{c} | 63.46 ± 4.95^{bc} | 51.91 ± 0.95^{cd} | 15^{a} |
| TG | 5.31 ± 0.08^{b} | 3.08 ± 0.03^{b} | 94.51 ± 0.33^{a} | 57.69 ± 1.39^{b} | 11^{d} |
| Guar | 3.62 ± 0.04^{d} | 2.62 ± 0.04^{cd} | 97.94 ± 0.34^{a} | 96.31 ± 0.95^{a} | 9^{e} |
| Arabic | 2.66 ± 0.01^{f} | 2.50 ± 0.06^{d} | 57.79 ± 4.05^{c} | 52.11 ± 2.81^{c} | 13^{b} |
| PG-Guar | 5.06 ± 0.02^{c} | 3.36 ± 0.05^{a} | 100.00 ± 0.00^{a} | 97.74 ± 0.08^{a} | 12^{c} |
| PG-Arabic | 3.27 ± 0.03^{e} | 2.75 ± 0.04^{c} | 67.57 ± 1.48^{b} | 56.71 ± 2.15^{b} | 15^{a} |
| TG-Guar | 5.62 ± 0.04^{a} | 2.98 ± 0.07^{b} | 100.00 ± 0.00^{a} | 100.00 ± 0.00^{a} | 9^{e} |
| TG-Arabic | 5.21 ± 0.06^{b} | 2.70 ± 0.02^{c} | 66.51 ± 4.65^{b} | 54.62 ± 1.97^{bc} | 9^{e} |

The PG-Guar also exhibited a significantly higher water holding capacity of 5.06 g/g. Transglutaminase catalyzed covalent crosslinking between lysine and glutamine residues in forming inter- or intra-molecular ϵ-(γ-Glu)-Lys polymers, which resulted in larger protein molecules and more intensive protein aggregation, favoring water holding capacity. Further, the newly formed crosslinking structures may enhance protein gel formation with better water holding capability due to the stronger hydrogen-bonded water shown in Raman bands. The pea proteins modified by protein glutaminase or guar gum alone also had improved water holding capacity up to 3.62 g/g compared with the control. With sequential modification using both protein glutaminase and guar gum, the water holding capacity was further improved to 5.06 g/g, implying synergistic effects from multiple modification approaches.

The control pea protein had an oil holding capacity of 2.76 g oil/g protein, which was more than twice of that reported for commercial pea protein (1.03 g/g). Among all the modified pea proteins, the PG-Guar protein exhibited significantly higher oil holding capacity than the control and other treatments (Table 12). However, the oil holding capacity of the protein deamidated by protein glutaminase or conjugated with guar gum alone did not significantly differ from the control protein, which may be attributed to their lower surface hydrophobicity as compared to the control or PG-Guar (Table 11). The PG-Guar treatment showed synergistic effect benefiting oil holding capacity. The oil holding capacity of pea protein conjugated with guar gum was similar to the control protein in this study, all around 2.6-2.7 g/g. We have reported that the commercial pea protein conjugated with guar gum had significantly increased oil holding capacity (2.02 g/g) than the control protein (1.03 g/g). This was because the heat treatment during the conjugation had altered and unfolded protein structures, and more hydrophobic amino acid residues were exposed, resulting in improved oil holding capacity.

### 3.7 Emulsifying Properties

The emulsifying characteristics of proteins, including emulsion capacity (EC) and emulsion stability (ES), are affected by the rate of protein adsorption and the ability to reorganize at the oil/water interface during emulsifying. The protein molecules act as barrier against the droplet coalescence and provide steric and electrostatic repulsions against flocculation in forming stable interfacial layer. As shown in Table 12, some of the modified pea proteins possessed greatly (p<0.05) improved emulsifying properties than the control pea protein (EC: 58%, ES: 48%), especially for the treatments involving guar gum, such as Guar, PG-Guar, and TG-Guar with emulsion capacity of 97 -100% and emulsion stability of 96-100%. Additionally, the pea proteins that conjugated with gum arabic (i.e., Arabic, PG-Arabic, TG-Arabic) had similar emulsifying properties as the control. Gum arabic has a very different structure compared with guar gum, and it is a complex mixture of glycoproteins and polysaccharides predominantly consisting of arabinose and galactose. After conjugating with pea protein, the proteins with guar gum seem to have a more balanced hydrophilicity and hydrophobicity that favored their surface activities at oil/water interface compared to the proteins with gum arabic. Gum arabic had a relatively low hydration radius and effective volume, and it is less viscous than guar gum when applied at the same concentration in water. The conjugated proteins with gum arabic might be insufficient to span the surface of oil droplet when used at the same concentration as the protein conjugates with guar gum, resulting in the destabilization or flocculation of protein emulsions.

The emulsifying properties of the protein deamidated by PG were not significantly different from the control, while the protein crosslinked by TG had significantly increased emulsion capacity and stability, although the stability was still much lower than those conjugated with guar gum. The interfacial film formed by the crosslinked protein by transglutaminase had higher resistance to destabilization, and relatively lower solubility of the crosslinked protein enabled a thicker interface with better steric stability, thus improved emulsion capacity. However, the absorption of the crosslinked proteins at the oil and water interface was not able to sustain the environmental stress (e.g., high temperature and shearing) during stability tests due to the larger molecular sizes and lack of molecule flexibility, which led to lower surface coverage and decreased emulsion stability. The pea protein deamidated by protein glutaminase had no significant differences with the control protein, because the protein deamidation had increased carboxylic acid residues and improved electrostatic repulsion, but it might weaken the hydrophobic interaction and hydrogen bonds, which resulted in structures that were less surface active. In summary, the sequential enzymatic modification and conjugation (PG-Guar and TG-Guar) had synergistic effects on the emulsifying properties, implying that protein functionalities could be better enhanced by combining different modifications approaches.

### 3.8 Protein Gelation Property

Heat-induced gelation is one of the most important functional properties of protein, as it is associated with the texture, quality, and sensory aspects of the foods. When pea protein slurry was heated above the denaturation temperature, the globulins were unfolded and rearranged to form soluble aggregates; while when the protein solution was cooled, the electrostatic repulsions were reduced between the aggregated proteins, and the proteins were assembled to form the structured get network entrapping water molecules. The control pea protein had a good gelation potential, with a least gelation concentration (LGC) of 11%, which was much lower than that of commercial pea protein (LGC of 18%). The modified pea proteins from guar gum conjugation (i.e., Guar) or transglutaminase crosslinking plus conjugation (i.e., TG-Guar, TG-Arabic) had further significantly improved gelation property with LGC of 9%, compared with the control protein (Table 12). The inclusion of guar gum during the protein conjugation can unfold the protein structure and enhance the hydrophobic interaction to create more stable and firm gel networks.

The addition of transglutaminase in the protein promoted the crosslinking among protein molecules and improved gelation ability. The proteins deamidated by glutaminase (i.e., PG, PG-Arabic, PG-Guar) had significantly decreased gelling property than the control, which might be partially attributed to the increased electrostatic repulsion between carboxylic acid groups. The pea protein conjugated with gum arabic alone did not show gelation improvement, as contract to that with guar gum. This was probably related to the lower viscosity of gum arabic in water than guar gum. In addition, others reported that the taro starch with guar gum had lower swelling power due to the fact that the tightening of starch granules restricted the exudation process, and improved gelation property. However, the gum arabic effectively facilitates the water penetration and eventually increases the swelling power due to the increased interactions between gelatinized starch granules; thus, the taro starch with gum arabic exhibited poorer gelation. Some of the polysaccharide properties may be carried over to the conjugated proteins and affect protein functional properties. The protein crosslinked by transglutaminase and followed by conjugation showed synergistic advantage in improving gelation property. These combined modification approaches could be used in many food applications that rely on protein gelation, such as condiments, meat patties, dairy, and cake batter products.

### 3.9 In Vitro Gastrointestinal Digestibility

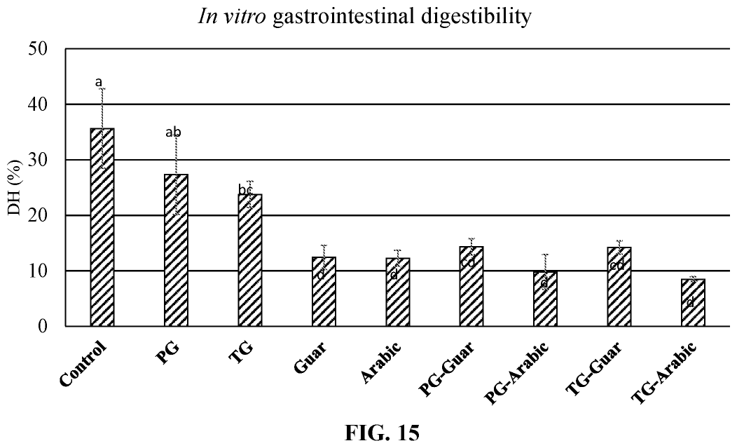

The digestibility of the pea and modified pea proteins was determined and presented as degree of hydrolysis of the proteins after the in vitro gastrointestinal digestion (FIG. 15). Overall, the modified pea proteins showed significantly decreased digestibility (p<0.05) compared with the control pea protein, except for the sample PG, which was also reduced but not significantly different from the control (p>0.05). The conjugated proteins and the proteins modified by a combination of enzymatic crosslinking and conjugation had increased molecular weight and were more potent to aggregate; thus, they became less accessible to the digestible enzymes as compared with the control. Some have reported that soy and chickpea proteins crosslinked with transglutaminase also had decreased digestibility. The treatment of pea protein with protein glutaminase increased protein electrostatic repulsion, which may favor enzyme accessibility during digestion. Others have reported that the deamidated gluten had decreased pepsin digestibility, which was attributed to the acidic shift of the protein's isoelectric point after deamidation and resulted in more protein aggregates under pepsin digestion condition (pH=2). However, the digestibility of the deamidated gluten was increased during pancreatin digestion due to increased solubility and loss of protein structures.

### 3.10 Descriptive Sensory Analysis

The sensory scores from descriptive analysis are summarized in Table 13, using the following reference points and definitions, and cleanout with Mozzarella cheese, unsalted crackers.

Beany: A slightly brown, musty, slightly nutty and starchy flavor associated with cooked beans.

Reference: Bush's Best Pinto Beans=7.5 (f)

Preparation: Drain beans and rinse with de-ionized water. Serve in 3.25 oz cups.

Grain: A general term used to describe the aromatic which includes musty, dusty, slightly brown, slightly sweet and is associated with harvested grains and dry grain stems.

Reference: Cereal Mixture (dry)=8.0

Preparation: Mix 1 cup of each General Mills Rice Chex, General Mills Wheaties and Quaker Quick Oats. Put in a blender and “Pulse” blend into small particles. Serve 1 tsp in 1 1 oz cup.

Green (grass): A green aromatics associated with newly cut-grass and leafy plants; characterized by sweet and pungent character.

Reference: Fresh parsley water=7.0 (f)

Preparation: Fresh parsley water: 50 g chopped fresh curly parley soaked in 600 mL room temperature de-ionized water for 15 minutes, filtered. Serve in 1 oz cups.

Green (Pea Pod): A green aromatic associated with fresh green peapods. May include beany, increased pungent, musty/earthy, bitter and astringent.

Reference: Kroger Frozen Lima Beans=9.0 (f)

Preparation: Serve about beans (thawed) in 3.25 oz cups.

Mouthfeel, Powdery: The feeling of undissolved starch from vegetable product such as potatoes and beans, left in the mouth after swallowing

Reference: Bush's Best Pinto Beans=7.0

Preparation: Drain beans rinse with de-ionized water. Serve in 3.25 oz cups.

Pulpy: The quantity or amount of perceivable pulp. Evaluated by manipulating the sample with the tongue 3-5 times in the mouth.

Reference: Tropicana Grovestand Orange Juice (carton)=5.0

Preparation: Serve in 3.25 oz cups.

Starchy: The dry aromatics associated with starch and starch based grain products such as wheat, rice, oats and other grains.

Reference: Argo Corn Starch in Water=3.0 (f)

Preparation: Mix 2 g corn starch in 200 mL water. Serve in 1 oz cups.

Umami: A general term for aromatics associated with juices from cooked seafood, meat and/ or vegetables.

Reference: Botton Mushroom Broth=2.0 (f)

Preparation: Add 2 cups water and 2 medium-size button mushrooms into a small sauce pan, bring to a boil and then boil for 5 minutes. Strain through a coffee filter and serve the liquid in 1 oz cups.

Astringent: The dry, puckering mouth feel associated with an alum solution in the mouth.

Reference: 0.05% Alum Solution=2.5

Reference: 0.07% Alum Solution=3.5

Bitter: The fundamental taste factor associated with a caffeine solution.

Reference: 0.02% Caffeine Solution=3.5

Reference: 0.035% Caffeine Solution=5.0

Metallic: The flavor aromatics described as flat associated with iron, copper, and silver spoons.

Reference: 0.10% Potassium Chloride Solution=1.5

Sweet: A fundamental taste sensation of which sucrose is typical.

Reference: 2% Sucrose Solution=2.0

Reference: 3% Sucrose Solution=3.0

TABLE 13
Sensory descriptive analysis score of pea and the modified pea proteins.

| | | | | | | Powdery | | | | |
|---|---|---|---|---|---|---|---|---|---|---|
| Sample | Beany | Starchy | Grain | Green | Pulpy | mouthfeel | Umami | Astringent | Bitter | Metallic |
| Control | 6 | 6 | 5 | 3 | 0 | 5.5 | 2 | 2.5 | 2.5 | 1.5 |
| PG | 5.5 | 5 | 6 | 3 | 0 | 5.5 | 0 | 2.5 | 2 | 1.5 |
| TG | 6 | 6.5 | 5 | 2.5 | 5 | 5 | 2 | 2 | 3 | 0 |
| Guar | 6.5 | 7 | 4.5 | 2.5 | 0 | 5.5 | 2 | 2.5 | 2.5 | 1.5 |
| Arabic | 6 | 4 | 6 | 3 | 0 | 5 | 2 | 2.5 | 2 | 1.5 |
| PG-Guar | 6 | 6 | 4.5 | 2.5 | 0 | 5 | 0 | 2 | 2 | 1.5 |
| PG-Arabic | 5 | 5 | 5 | 3 | 0 | 5 | 2 | 2.5 | 2.5 | 1.5 |
| TG-Guar | 6 | 6 | 5.5 | 2.5 | 3 | 5.5 | 0 | 2.5 | 3 | 1.5 |
| TG-Arabic | 6 | 5 | 5 | 3 | 3 | 6 | 2 | 2.5 | 2.5 | 1.5 |

Note:
The descriptive analysis was conducted using intensity scale with 0.5 increments (0 = none; 15 = extremely intense).

Overall, the modified pea proteins had comparable sensory scores for most attributes as the control pea protein, and all the modification treatments did not obviously decrease most sensory scores (Table 13). One interesting observation is that the proteins crosslinked with transglutaminase (e.g., TG, TG-Guar, TG-Arabic) had obviously increased pulpy mouthfeel (scores 3-5) compared with the control (score 0), which was attributed to the increased protein molecular sizes and aggregation because of crosslinking. The umami taste of several modified proteins (PG, PG-Guar, TG-Guar) was reduced to zero compared with the control (score 2). All the modified proteins had similar scores for beany related attributes (beany, green, astringent, bitter, and metallic) as the control.

### 4 Conclusions

Enzymatic modification and/or conjugation with polysaccharides altered pea protein secondary structure compositions, molecular sizes, surface hydrophobicity, and contents of free sulfhydryl and amino groups, thus resulting in different functional characteristics. The pea proteins conjugated with guar gum (i.e., Guar, PG-Guar, TG-Guar) had greatly enhanced emulsifying properties compared with the control pea protein. The pea proteins crosslinked by transglutaminase (i.e., TG, TG-Guar, TG-Arabic) had water holding capacity twice of that of the control. Sequential modification of pea protein with transglutaminase and guar gum (TG-Guar) led to multiple functional enhancement of pea protein, including increased water holding capacity, oil holding capacity, emulsion capacity, emulsion stability, and gelation, and decreased protein solubility. The modified pea proteins had comparable sensory scores as the control pea protein, and these modifications overall did not negatively affect protein sensory properties. However, the modified pea proteins showed decreased in vitro gastrointestinal digestibility compared with the control protein. The newly developed pea proteins through green modifications may expand their uses in various food applications and better meet the increasing demand for more functional plant proteins.

### Example 4

### Emulsifying Properties and Mayonnaise Application of Pea Protein Conjugated with Guar Gum

These examples demonstrate using the modified pea protein in in emulsified food applications, such as in mayonnaise.

### Abstract:

Plant proteins are receiving increasing interest. Modified plant protein may be used as a healthy and more functional emulsifier in food products. The objective of this study was to evaluate the emulsifying properties of functionally enhanced pea protein (i.e., pea protein conjugated with guar gum, G-PPI) and its potential application in mayonnaise, compared with unmodified pea protein. Emulsions containing G-PPI were prepared at different pH, salt concentrations, protein concentrations, and oil/water ratios. Mayonnaise samples were prepared using the pea proteins or egg yolk powder. Various characteristics of the emulsions, including particle size, apparent viscosity, viscoelasticity, and microstructure were analyzed. The emulsions with G-PPI had significantly increased stability of up to 89.4% and apparent viscosity of up to 48.62 mPa.s. The G-PPI emulsion had a smaller average droplet size of 934.4 nm at pH 7 compared with the PPI emulsion (stability 62.7%, apparent viscosity 22.8 mPa.s, droplet size 1664.8 nm). The pH, NaCl concentration, protein concentration, and oil/water ratio greatly affected the emulsifying properties. The G-PPI mayonnaise at higher protein concentrations (6 or 8%) exhibited excellent emulsifying and rheological properties. The modified pea protein through the green process could be used as a safe and functional emulsifier in different emulsified foods.

### Introduction

Plant proteins are receiving increasing interest in food and ingredient applications due to their advantageous features, such as lower cost and more sustainable nature compared with animal-sourced proteins. Pea proteins extracted from yellow pea (Pisum sativum L.) are among the most widely used plant proteins, only after soy proteins and wheat gluten. Pea protein consists of 15-25% water-soluble albumin and 65-80% salt extractable globulin, and it contains high levels of essential amino acids such as lysine, threonine, and tryptophan. The major globulin proteins in pea include legumin and vicilin, as well as a small amount of convicilin. Pea protein, as a promising plant protein, has excellent food application potentials due to its nutritional value, health benefits, less allergenicity, and diverse functional attributes. However, commercial pea proteins tend to have lower solubility and less desirable functionalities.

Polysaccharide gums are complex hydrophilic polymers with many functional properties, and they have been widely used in the food industry as thickeners, gelling agents, textural modifiers, etc. Protein-polysaccharide conjugation is a chemical-free, mild, and safe modification method to improve protein functional properties such as emulsifying, foaming, and gelling. Conjugation reaction builds chemical linkages between the two polymers by condensing the C-amino group of the protein and carbonyls of the polysaccharide during early-stage Maillard reaction. In the conjugation process, non-covalent electrostatic interactions can also contribute to the formation of a new polymeric complex. In the early stage, the Maillard reaction mainly induces the non-covalent electrostatic interactions between protein and polysaccharides in forming new hybrid polymers with light color. The advanced Maillard reaction may accelerate the chemical reaction and form a less soluble polymer with a much darker color. The covalent linkages of protein and polysaccharides may deliver better molecular integrity than non-covalent interactions. The formation of protein and polysaccharide conjugate and complex can promote the structural and textural characteristics of food products via their aggregation and gelling behaviors. Several previous studies reported that pea protein conjugated with polysaccharides had significantly improved emulsifying properties. Some reports have indicated that pea protein conjugated with gum arabic possessed better emulsifying properties. The resultant oil-in-water emulsions had smaller droplet size, higher surface charge, and stronger steric hindrance. Further, some studies reported that the pea protein conjugated with pectin showed good rheological behavior in oil-in-water emulsions.

Guar gum is a high molecular weight polysaccharide extracted from guar bean (Cyamopsis tetragonolobus). The chemical structure of guar gum consists of a straight chain of D-mannose unit linked by β-(1-4) glycoside linkages with mannose to galactose ratio of 2: 1. Recently, we developed a functionally enhanced pea protein through conjugation modification with guar gum based on wet Maillard reaction. This novel ingredient exhibited excellent water and oil holding capacities, solubility, emulsifying, and gelling properties. Emulsions are widely used in food, cosmetic, and pharmaceutical applications. They are colloidal systems and consist of two immiscible liquids (i.e., water and oil), which are thermodynamically unstable because of several physical mechanisms such as gravitational separation, coalescence, flocculation. Protein can reduce the interfacial tension between water and oil phases and enhance emulsion stability through the formation of viscoelastic layers on the droplets and generating repulsive steric and electrostatic interactions between the droplets. On the other side, native pea protein is a less effective emulsifier compared with synthetic surfactants or emulsifiers. The modification approach is necessary for the protein to possess better emulsifying properties and steric stabilization.

Mayonnaise is a semi-solid oil-in-water emulsion made with several major ingredients such as egg yolk, vinegar, oil, and water. The stability of mayonnaise depends on the amount of oil, water, egg yolk, other ingredients, and production methods. Due to the health concern of cholesterols in egg yolk, the replacement of egg yolk with plant proteins for mayonnaise-like dressing preparation has attracted more interest. The objective of this study was to evaluate the emulsifying properties of the guar gum conjugated pea protein (G-PPI) at different pH conditions, salt concentrations, protein concentrations, and oil/water ratios, as well as its application in mayonnaise. Emulsion and mayonnaise properties, including particle size, zeta potential, apparent viscosity, viscoelasticity, and microstructure were characterized. This study will benefit researchers and food industries interested in utilizing plant protein in various food applications.

### Materials and Methods

### Materials

Pea protein isolate (83% protein content) was obtained from a commercial manufacturer. Guar gum was purchased from Judee's (Plain City, OH, USA). Soybean oil was purchased from Healthy Harvest Production, LLC (Berthoud, CO, USA).

### Preparation of Modified Pea Protein (G-PPI)

The modified pea protein (G-PPI) was prepared by mixing pea protein isolate (PPI) with 5% guar gum (based on PPI) in aqueous suspension (10% PPI concentration) through a wet heat Maillard reaction at 60° C. for 24 hours in a water bath shaker (LabRepCo, Horsham, PA, USA). The slurry was then lyophilized with a freeze dryer (FreeZone® 4.5L Benchtop Freeze Dryer, Labconco®, Kansas City, MO, USA), and the dried conjugate powder was ground and kept at 4° C. for further analysis and emulsion and mayonnaise preparations.

### Preparation of Emulsions and Mayonnaises

Emulsion preparation: For emulsions based on the unmodified pea protein, the PPI (0.75 g, or 1.5% w/v based on total water and oil volume) was added into deionized (DI) water (25 mL), which was then vortexed for 30 seconds to dissolve and disperse the PPI. Soybean oil (25 mL) was then added to the protein slurry. The mixture was treated with a high-performance homogenizer (Fisher Scientific, Fair Lawn, NJ, USA) for 2 min at 20,000 rpm. Emulsions with different variables were prepared similarly except that the parameters were adjusted to the set conditions (pH, NaCl concentration, protein concentration, oil/water ratio). For the modified protein G-PPI, emulsions were prepared with varied pH conditions (3, 5, 7, and 9), salt concentrations (0.01, 0.1, and 1 M NaCl), protein concentrations (1, 1.5, and 2% w/v based on total water and oil volume), and ratios of oil/water (10:90, 30:70, 50:50, 70:30, and 90:10). Emulsions with the control pea protein at pH (3, 5, 7, and 9), 0.1 M NaCl, 0.75 g protein concentration (i.e., 1.5% w/v), and 50:50 oil/water ratio were also prepared similarly for comparison.

Mayonnaise preparation: The formulation of low-fat mayonnaise was based on a reference (Liu et al. (2018). Wheat gluten-stabilized high internal phase emulsions as mayonnaise replacers. Food Hydrocolloids, 77, 168-175.) with minor modifications. The basic mayonnaise formulation included 25 mL soybean oil, 23.5 mL water, 1.5 mL vinegar, 0.75 g sugar, 0.35 g salt, and varying amounts of proteins (2 —10% based on total liquid volume (oil, water, and vinegar, 50 ml)), namely egg yolk powder (Modernist pantry, Eliot, ME, USA), unmodified pea protein (PPI), or modified pea protein (G-PPI). Briefly, all the ingredients except for oil were homogenized in a Waring blender for 30 seconds. Soybean oil was then added into the suspension and homogenized for another 30 seconds. The mayonnaise sample was collected and stored in a glass jar at 4° C. for further analysis within two days.

### Functional Properties of Pea Proteins

Protein functional properties, including water and oil holding capacities, solubility, least gelation concentration, and emulsion capacity and stability, were measured according to our previous methods without any modifications.

### Protein Zeta Potential and Emulsion Particle Size

The zeta potential values of protein solutions and the particle size of emulsion droplets were measured using a dynamic light scattering analyzer (DelsaMax Pro, Beckman Coulter, Indianapolis, IN, USA) with a flow cell attachment and DelsaMax Assist unit. For zeta potential analysis of PPI and G-PPI, the protein was dispersed in DI water at 1%, and pH was adjusted to 3, 4, 4.5, 5, 7, 9, and 11, respectively. The protein dispersions were centrifuged at 10,000×g for 5 min, and the supernatants were collected, which were further diluted (1:100 v/v) with citrate buffer (for pH 3, 4, 4.5, and 5), phosphate buffer (pH 7), or glycine-NaOH buffer (for pH 9 and 11). For emulsion particle size analysis, emulsion samples were prepared similarly as described in the emulsion preparation section and diluted by 100 times with DI water and then injected into the flow cell using a syringe at 20±1° C.

### Apparent Viscosity

The apparent viscosity of the emulsions was measured using a rheometer (MCR-92 Anton Paar, Ashland, VA, USA) having cone and plate geometry with a Peltier temperature control. A 50 mm cone plate with an angle of elevation of 1° was used as the measuring geometry, and the measurements were carried out at 25° C. The viscosity and shear stress as a function of shear rate was determined using steady-state flow tests in a range of 0.1 to 100 s⁻¹. The measurement was conducted in duplicate.

### Rheological Properties

The viscoelastic properties of mayonnaise samples were measured using the same rheometer (MCR-92 Anton Paar, Ashland, VA, USA) equipped with a 25-mm parallel plate geometry (PP25) with the measure gap of 1 mm at a constant temperature of 25±0.1° C. Frequency sweep (frequency range of 0.1-100 Hz, at 0.5% strain) and temperature sweep (from 30-80° C.) were carried out, and storage modulus (G′) and loss modulus (G″) were collected. The tests were conducted in duplicate.

### Microstructure

Images of emulsions and mayonnaises were taken using an optical microscope (Olympus America Inc., Melville, NY, USA) connected to a digital camera (Ken-a-vision, Kansas City, MO). One drop of the sample was transferred onto the microscope glass slide (Fisher Scientific, Pittsburgh, PA, USA), and the sample was then covered with a cover-slip (Fisher Scientific) and viewed with a 40 x objective lens. The images were collected with the Lightscreen software and processed with Image J software.

### Statistical Analysis

All the data were analyzed using SAS University Edition software (SAS Institute, Cary, NC, USA), with one-way ANOVA and Tukey's post-hoc comparison test. Significant difference among all the data sets was evaluated at p<0.05. The results were presented as mean±standard deviation.

### Results and Discussion

### Protein Functional Properties

The conjugated pea protein (G-PPI) possessed significantly greater (p<0.05) water and oil holding capacities, solubility (pH 7), and gelation property than the unmodified pea protein (i.e., PPI) (Table 14).

TABLE 14
Functional properties including water and oil holding capacities
(WHC, OHC), solubility (pH 7), and least gelation concentration
(LGC) of pea protein isolate (PPI) and modified pea protein
(G-PPI). *Means with different letters in each column indicate
significant differences (p < 0.05).

| Samples | WHC, g/g | OHC, g/g | Solubility, % | LGC, % |
|---|---|---|---|---|
| PPI | 4.09 ± 0.02^{b} | 1.35 ± 0.04^{b} | 22.89 ± 0.47^{b} | 17^{a} |
| G-PPI | 4.99 ± 0.04^{a} | 2.54 ± 0.04^{a} | 64.66 ± 2.04^{a} | 12^{b} |

Water and oil holding capacities of G-PPI reached 4.99 and 2.54 g/g compared with the control protein (4.09 and 1.35 g/g), respectively. Solubility of G-PPI was increased to 64.66%, compared with the control (22.89%). The G-PPI also exhibited improved gelation property (with least gelation concentration, LGC, of 12%) than the control (LGC of 17%). During the conjugation modification, the inclusion of guar gum to the protein molecules enhanced the hydrophilicity of the complex and altered the original balance of protein hydrophilicity/hydrophobicity, which resulted in improved solubility and emulsification properties. The more hydrophilic guar gum domains in the complex enhanced the affinity between water and the complex; thus, the water holding capacity was also increased. Moreover, the heat treatment during protein and polysaccharide conjugation unfolded protein globular structures and exposed more hydrophobic amino acid residues to the protein surface, which contributed to the improved oil holding capacity. Guar gum had gel thickening properties, and the inclusion of guar gum in the new complex enhanced protein interactions in forming more stable gel networks.

### Protein Zeta Potential

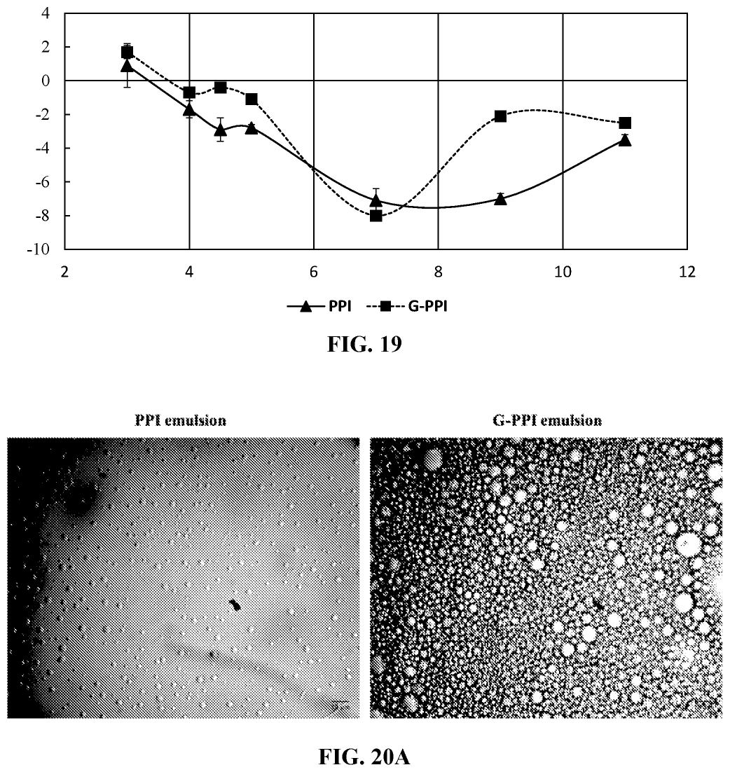

Various repulsive and attractive forces are involved in interactions that influence the stability of protein colloidal systems. Zeta potential indicates the magnitude of electrostatic interaction among particles. When the particles carry some net charges, either positive or negative charge, the repulsive forces play a predominant effect, which prevents protein suspensions from aggregation. In contrast, when the net charge is close to zero, attractive forces become more essential, resulting in particles' aggregation and precipitation. The colloid stability and surface charge of protein particles are dependent on the pH of the medium. The zeta potential of PPI and G-PPI at different pH conditions is shown in FIG. 19. The PPI carried net negative charges in the alkaline medium with the maximum net charge at pH 7-9. The net charge was reduced when the pH decreased as it was near the isoelectric point (pH 3-4). Similarly, the maximum net charge of G-PPI was around pH 7, and the isoelectric point was around pH 4-5. However, when at pH 9, the net charge of G-PPI was decreased greatly compared to the PPI. This result may be attributed to the hydrophobic interactions between the unfolded protein and guar gum during the conjugation process.

### Emulsifying Properties of Pea Proteins

The emulsifying properties (e.g., emulsion capacity and stability) of oil-in-water emulsions containing the pea proteins with different formulations and environmental conditions are summarized in Table 15.

TABLE 15
Emulsifying properties including emulsion capacity (EC) and stability (ES) of emulsions
at different pH, NaCl concentrations, protein concentrations, and oil/water ratios.

PPI

| pH | pH 3 | pH 5 | pH 7 | pH 9 | 0.1M NaCl | 1.5% PPI |
|---|---|---|---|---|---|---|
| EC (%) | 89.65 ± 5.07^{b} | 44.70 ± 3.66^{d} | 83.64 ± 1.58^{b} | 97.63 ± 0.63^{a} | 64.76 ± 3.21^{c} | 84.90 ± 0.19^{b} |
| ES (%) | 67.24 ± 1.70^{bc} | 0 | 62.66 ± 1.06^{bc} | 69.81 ± 2.08^{a} | 60.56 ± 4.68^{d} | 65.17 ± 1.50^{bcd} |

G-PPI

| pH | pH 3 | pH 5 | pH 7 | pH 9 |
|---|---|---|---|---|
| EC (%) | 98.85 ± 0.24^{a} | 73.62 ± 0.97^{c} | 97.05 ± 0.28^{b} | 97.95 ± 0.52^{ab} |
| ES (%) | 88.94 ± 2.12^{b} | 0 | 89.37 ± 0.74^{b} | 93.72 ± 0.93^{a} |

| NaCl | 0.01M | 0.1M | 1M |
|---|---|---|---|
| EC (%) | 98.95 ± 0.20^{b} | 99.51 ± 0.14^{a} | 99.15 ± 0.27^{ab} |
| ES (%) | 96.57 ± 1.23^{ab} | 97.57 ± 0.37^{a} | 95.69 ± 0.36^{b} |
| Protein | 1% | 1.5% | 2% |
| EC (%) | 90.02 ± 1.29^{c} | 97.69 ± 0.49^{b} | 99.50 ± 0.03^{a} |
| ES (%) | 73.34 ± 1.64^{c} | 92.72 ± 0.69^{b} | 98.20 ± 0.28^{a} |

| O/W ratio | 10/90 | 30/70 | 50/50 | 70/30 | 90/10 |
|---|---|---|---|---|---|
| EC (%) | 13.27 ± 1.55^{b} | 99.10 ± 0.02^{a} | 98.77 ± 0.32^{a} | 100 ± 0^{a} | 0 |
| ES (%) | 21.67 ± 3.69^{c} | 58.86 ± 1.07^{b} | 98.00 ± 0.41^{a} | 100 ± 0^{a} | 0 |

PPI: pea protein isolate;
G-PPI: modified pea protein;
*Means with different letters in each row indicate significant differences (p < 0.05).
Note:
For PPI emulsions, the pH 3-7 samples were prepared with 1.5% protein, 0M NaCl, 50/50 O/W; the 0.1M NaCl emulsion sample was prepared with 1.5% protein, 50/50 O/W, at original PPI pH (~pH 7.8); the 1.5% emulsion sample: 0M NaCl, 50/50 O/W at original the PPI pH.

For G-PPI emulsions, the pH variation samples were prepared at 0 M NaCl, 1.5% protein, 50/50 O/W; the NaCl variation samples were prepared at 1.5% protein, 50/50 O/W at G-PPI original pH; the protein concentration variation samples were prepared at 0 M NaCl, 50/50 O/W at G-PPI original pH; the oil/water ratio variation samples were prepared at 1.5% protein, 0 M NaCl at G-PPI original pH.

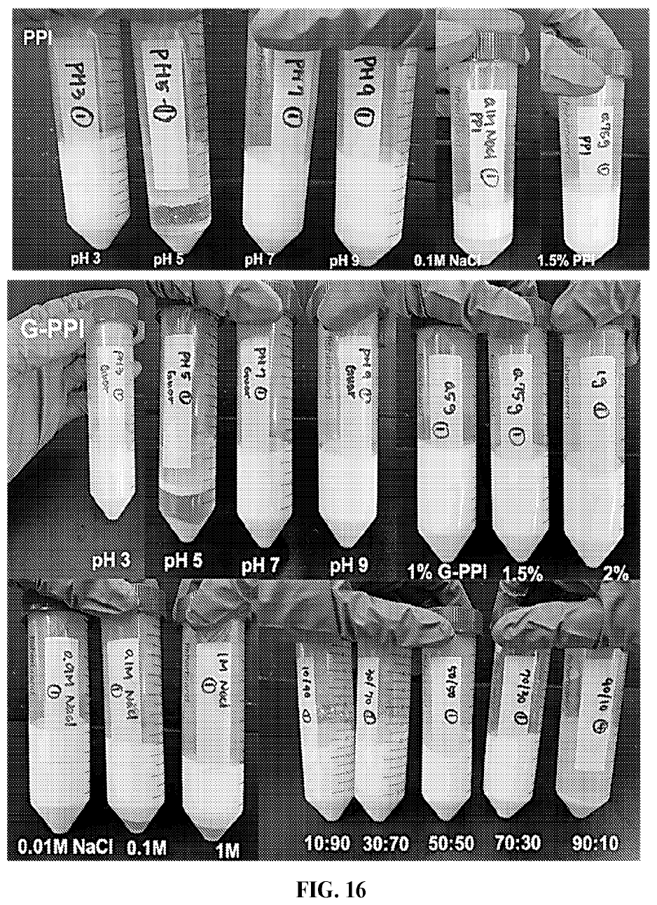

Overall, the G-PPI emulsions exhibited much better emulsion capacity and stability than the PPI emulsions at all conditions. They showed higher resistance against the flocculation, coalescence, and phase separation than the PPI emulsions, which may be attributed to the altered hydrophilicity/hydrophobicity balance of G-PPI and molecular flexibility that allowed easier unfolding and absorbance at the oil/water interface and resulted in more stable emulsions. The pH had a significant impact on emulsifying properties of the emulsions. For both PPI and G-PPI emulsions, when the pH was close to the isoelectric point (near pH 5), the emulsions exhibited poor stability, and phase separation occurred, with a transparent serum layer (FIG. 16). The G-PPI emulsions showed great emulsion stability at different salt conditions (0.1-1 M NaCl), with emulsion stability all above 95%. When the concentration of G-PPI increased from 1 to 2% in the emulsion, both emulsion capacity and stability were significantly improved. The increased protein concentration promoted oil droplets'surface coverage, enhanced protein adsorption, and effectively inhibited emulsion aggregation. Oil/water ratio is another important factor that could affect the emulsifying properties of a protein. For the modified pea protein G-PPI, when the oil/water ratio was extremely low or high, for example, at 10/90 or 90/10, the system cannot form a good emulsion, with very low values of emulsion capacity and stability (FIG. 16, Table 15). The emulsions with oil/water ratio of 50/50 or 70/30 had the best emulsion stability compared with other ratios. With 70/30 oil/water ratio, a highly viscous and stable emulsion gel (i.e., high internal phase emulsion) was formed. The emulsion stability was highly related to the relative oil/water phase volume ratio.

### Apparent Viscosity of Emulsions

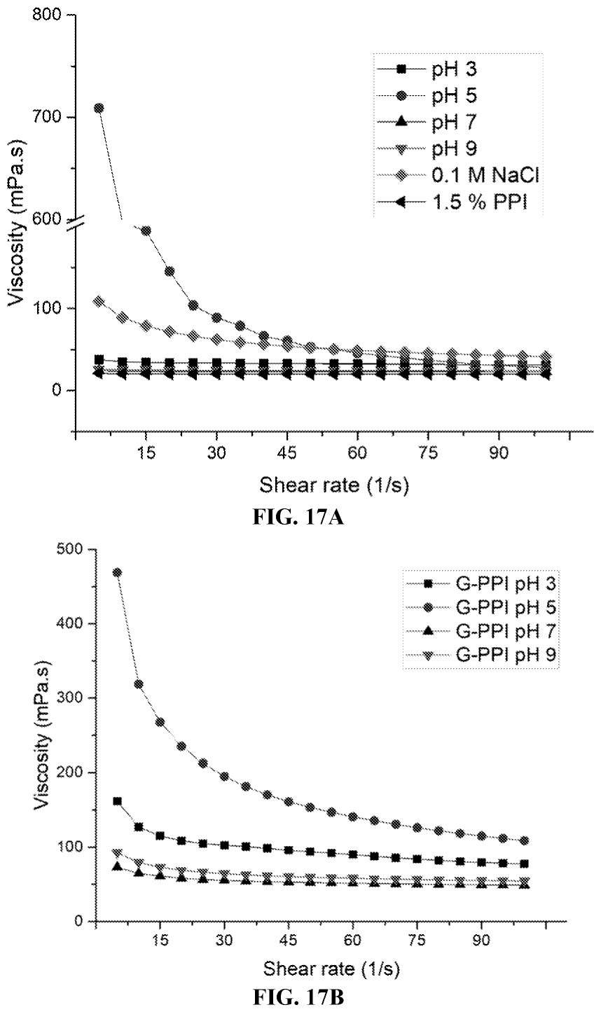

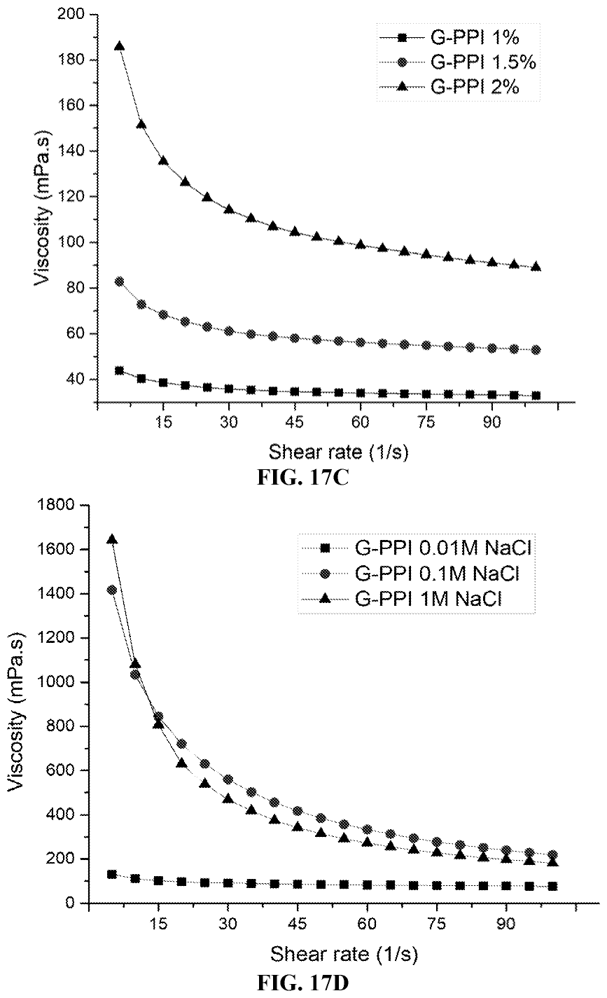

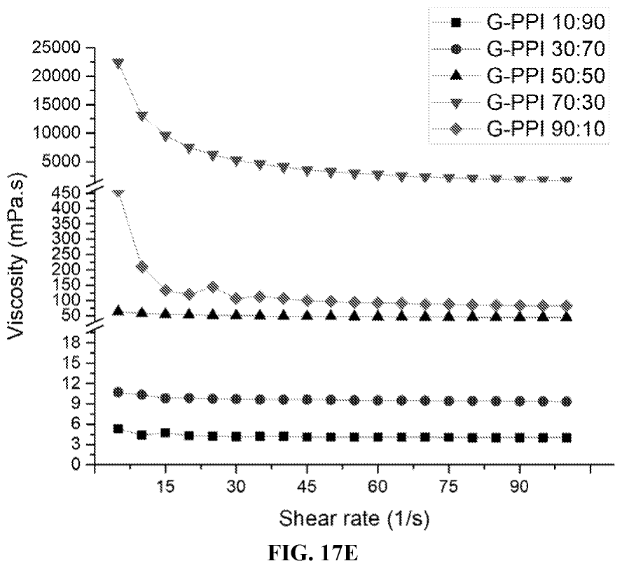

The apparent viscosity of the emulsions containing PPI and G-PPI is shown in FIG. 17, and the viscosity values at shear rate of 100 s⁻¹ are summarized in Table 16.

TABLE 16
Apparent viscosity (shear rate, 100 s⁻¹) and average particle size of emulsions
at different pH, NaCl concentrations, protein concentrations, and oil/water ratios
containing pea protein isolate (PPI) and the modified pea protein (G-PPI). *Means
with different letters in each row indicate significant differences (p < 0.05).

| PPI | Viscosity (mPa · s) | Diameter (nm) |
|---|---|---|
| pH 3 | 31.09 ± 0.42^{b} | 2231.95 ± 392.94^{bc} |
| pH 5 | 27.68 ± 1.42^{c} | 4904.15 ± 753.71^{a} |
| pH 7 | 22.80 ± 0.68^{d} | 1664.80 ± 71.42^{cd} |
| pH 9 | 24.00 ± 0.93^{d} | 1309.65 ± 9.55^{cd} |
| 0.1M Nacl | 41.34 ± 0.23^{a} | 3380.65 ± 184.06^{b} |

G-PPI

| pH | pH 3 | pH 5 | pH 7 | pH 9 |
|---|---|---|---|---|
| Viscosity (mPa · s) | 60.77 ± 4.15^{b} | 88.21 ± 6.40^{a} | 48.62 ± 1.32^{b} | 54.16 ± 1.58^{b} |
| Diameter (nm) | 1767.10 ± 308.30^{a} | 888.15 ± 41.51^{b} | 934.40 ± 157.12^{b} | 872.95 ± 33.30^{b} |
| NaCl Conc. | 0.01M | 0.1M | 1M | |
| Viscosity (mPa · s) | 76.60 ± 1.34^{b} | 174.48 ± 7.06^{a} | 149.17 ± 9.16^{a} | |
| Diameter (nm) | 605.00 ± 16.83^{b} | 885.35 ± 87.89^{a} | 1084.05 ± 73.47^{a} | |
| Protein Conc. | 1% | 1.5% | 2% | |
| Viscosity (mPa · s) | 32.89 ± 0.47^{c} | 52.90 ± 2.11^{b} | 89.04 ± 1.05^{a} | |
| Diameter (nm) | 727.30 ± 93.06^{a} | 803.30 ± 67.88^{a} | 588.95 ± 55.79^{a} | |

| Oil/water ratio | Viscosity (mPa · s) | Diameter (nm) |
|---|---|---|
| 10/90 | 4.01 ± 0.07^{b} | 377.25 ± 43.20^{c} |
| 30/70 | 9.34 ± 0.04^{b} | 969.50 ± 6.08^{ab} |
| 50/50 | 44.85 ± 1.34^{b} | 567.55 ± 39.39^{bc} |
| 70/30 | 1697.10 ± 117.95^{a} | 1494.00 ± 277.33^{a} |
| 90/10 | 82.76 ± 5.97^{b} | 668.70 ± 131.66^{bc} |

Note:
For PPI emulsions, pH 3-pH 7 emulsion samples: 1.5% protein concentration, 0M NaCl, 50/50 O/W; 0.1M NaCl emulsion sample: 1.5% protein, and 50/50 O/W at original PPI pH (~pH 7.8); 1.5% emulsion sample: 0M NaCl, 50/50 O/W at original PPI pH.
For G-PPI emulsions, pH variation samples: 0M NaCl, 1.5% protein, 50/50 O/W; NaCl concentration variation samples: 1.5% protein, 50/50 O/W at G-PPI original pH; Protein concentration variation samples: 0M NaCl, 50/50 O/W at G-PPI original pH; Oil/water ratio variation samples: 1.5% protein, 0M NaCl at G-PPI original pH.

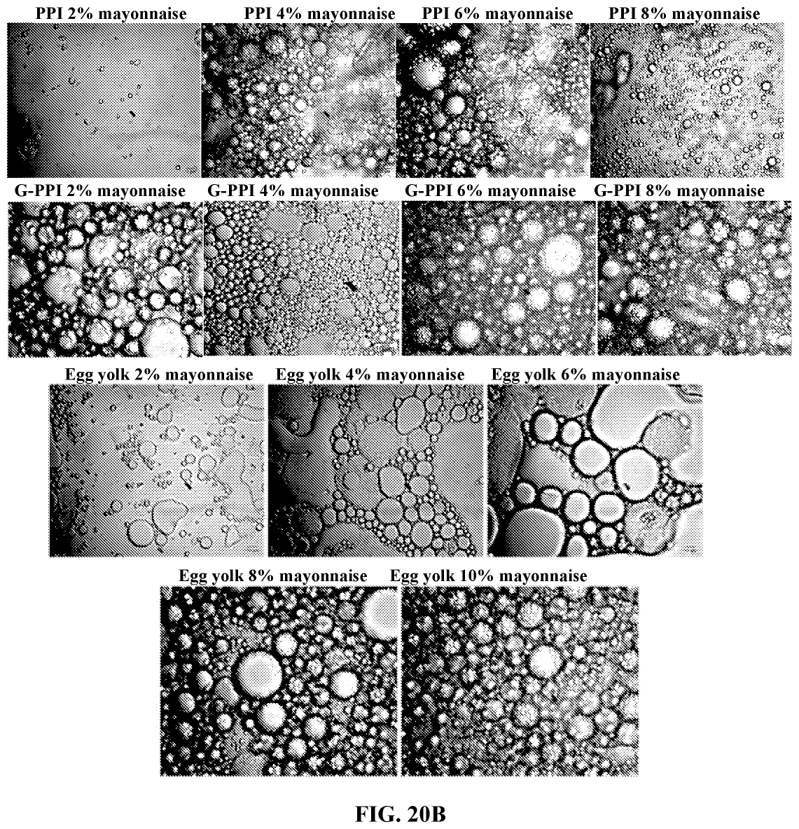

All the emulsions showed shear-thinning behavior between the shear rate of 0.1-100 s⁻¹, attributed to the breakdown of intermolecular interactions or linkages among droplet particles during the shearing. Overall, the G-PPI emulsions exhibited significantly higher viscosity than the PPI emulsions at the same pH, NaCl, or protein concentration (Table 16). This was because of the enhanced thickening and gelling properties of G-PPI in the aqueous phase, primarily attributed to the conjugated polysaccharide. Major factors affecting the viscosity of emulsions include droplet size and distribution, which may influence the degree of droplet flocculation, colloidal interactions among the droplets, such as van der Waal forces, hydrophobic interactions, electrostatic and steric interactions, and charges of emulsion droplets. The smaller particle size (Table 16) and uniform droplet size distribution (FIG. 20) of emulsions with G-PPI further confirmed its better emulsifying properties than PPI. At shear rate of 100 s⁻¹, the PPI emulsion showed the highest viscosity at pH 3 (31.09 mPa.s), while the highest viscosity of G-PPI emulsion was observed at pH 5 (88.21 mPa.s) among the different pH conditions investigated (Table 16). This result is in agreement with the zeta potential values that the PPI and G-PPI had the lowest absolute charge at pH 3 and 4.5, respectively (FIG. 19). The proteins had the lowest solubility around the isoelectric pH condition and formed protein aggregates that may contribute to the higher slurry viscosity.

When NaCl concentration increased from 0.01 to 1 M, viscosity of G-PPI emulsions was increased. The emulsions with 0.1 and 1 M NaCl showed significantly higher viscosity at 100 s⁻¹ than that with 0.01 M NaCl. The higher concentration of salt addition decreased the electrostatic repulsion forces, which favored protein aggregation through electrostatic and van der Waals attraction. It resulted in higher viscosity with larger droplet size for the emulsions (Table 16). When the G-PPI concentration increased from 1 to 2%, the emulsion viscosity (at 100 s⁻¹) increased from 32.89 to 89.04 mPa.s. Compared to PPI emulsions, pea protein and guar gum conjugation increased protein molecular size and resistance to flow; thus, the viscosity of G-PPI emulsions was significantly (p<0.05) increased. Further, a higher concentration of G-PPI in the emulsion also increased the apparent viscosity. The G-PPI emulsion with an oil/water ratio of 70: 30 showed exceptionally higher viscosity (1697.10 mPa.s) than the other emulsions. This was because the expansion of the water-protein matrix caused a large amount of oil to be entrapped in the matrix, and the interactions between hydrophobic protein domains and the oil molecules were enhanced. The high viscosity of the emulsion limits the motion of droplets and decreases the frequency of collisions among the droplets. These semi-solid-like emulsion gels can be potentially used as high-internal phase emulsions or for other hydrogel applications.

### Droplet Size of Emulsions

Average droplet size (i.e., hydrodynamic diameter) of the emulsions containing PPI or G-PPI is summarized in Table 16. Overall, the G-PPI emulsions exhibited a smaller particle size than the PPI emulsions at the same pH, NaCl, or protein concentration. This was because the pea-guar gum conjugate had the amphiphilic structure and provided a bulky steric stabilizing layer around the oil droplet and facilitates its absorption at the oil/water interface, and resulting in smaller droplet size. In the meantime, the absorption of G-PPI at the oil/water interface is fast enough to efficiently retard the aggregation and coalescence of the emulsion droplets. For the emulsion at different pH conditions, the PPI emulsion showed the largest particle size at pH 5, while the largest size of G-PPI emulsions was observed at pH 3. When the NaCl concentration increased from 0.01 M to 1 M, the emulsion particle size was increased from 605 to 1084 nm. This was because the protein aggregation or flocculation were formed via van der Waals attraction, which increased the viscosity and droplet size of the emulsions. When the protein (G-PPI) concentration increased from 1 to 2%, the emulsion particle size was decreased from 727 to 588 nm. However, there was no significant difference (p>0.05) in the average particle sizes of the emulsions with different protein concentrations. In addition, the emulsion with an oil/water ratio of 70:30 showed the largest particle size than at other oil/water ratios, which was attributed to its higher viscosity and extensive formation of aggregate networks.

### Mayonnaise Applications

### Mayonnaise Emulsion Capacity and Stability

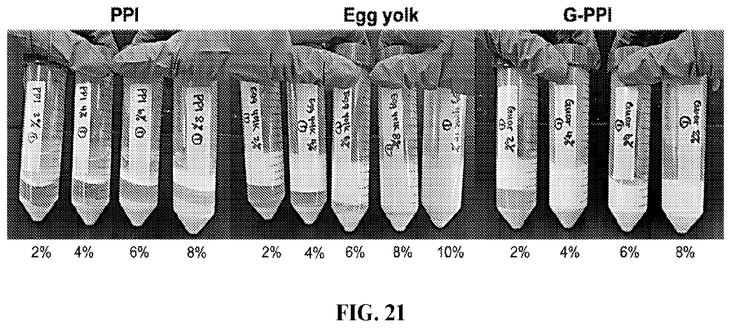

Mayonnaise dressings containing different amounts of PPI, G-PPI, or egg yolk powder were prepared (FIG. 20 and FIG. 21), and the emulsion properties were investigated. When the PPI, G-PPI, or egg yolk concentration increased, the emulsion capacity and stability increased (Table 17).

TABLE 17
Emulsifying properties, including emulsion capacity (EC) and stability
(ES) of mayonnaise at different protein or egg yolk concentrations, and
their viscoelastic properties (G′ and G″) at 1 Hz. *Means with
different letters in each row indicate significant differences (p < 0.05).

| | PPI 2% | PPI 4% | PPI 6% | PPI 8% |
|---|---|---|---|---|
| EC | 11.92 ± 2.06^{b} | 50.30 ± 0.61^{a} | 50.93 ± 1.19^{a} | 50.93 ± 1.19^{a} |
| ES | 6.57 ± 0.89^{d} | 10.49 ± 1.14^{c} | 13.04 ± 0.42^{b} | 25.79 ± 1.18^{a} |
| G′ | 0.39 ± 0.02^{b} | 2.41 ± 0.37^{a} | 0.88 ± 0.36^{b} | 0.00 ± 0.00^{b} |
| G″ | 1.35 ± 0.06^{a} | 1.99 ± 0.31^{a} | 1.80 ± 0.03^{a} | 1.49 ± 0.28^{a} |

| | Egg yolk 2% | Egg yolk 4% | Egg yolk 6% | Egg yolk 8% | Egg yolk 10% |
|---|---|---|---|---|---|
| EC | 63.30 ± 0.93^{d} | 69.81 ± 2.08^{c} | 84.20 ± 3.74^{b} | 93.75 ± 0.73^{a} | 97.87 ± 0.26^{a} |
| ES | 59.04 ± 4.29^{d} | 62.90 ± 0.80^{d} | 72.22 ± 1.01^{c} | 88.30 ± 0.54^{b} | 95.72 ± 0.66^{a} |
| G′ | 0.00 ± 0.00^{c} | 0.00 ± 0.00^{c} | 0.77 ± 0.00^{c} | 4.95 ± 0.22^{b} | 22.79 ± 2.13^{a} |
| G″ | 1.22 ± 0.13^{c} | 1.33 ± 0.02^{c} | 1.48 ± 0.15^{c} | 4.09 ± 0.02^{b} | 11.04 ± 0.18^{a} |

| | G-PPI 2% | G-PPI 4% | G-PPI 6% | G-PPI 8% |
|---|---|---|---|---|
| EC | 71.82 ± 4.32^{c} | 87.60 ± 1.29^{b} | 94.50 ± 2.02^{a} | 98.28 ± 0.23^{a} |
| ES | 54.76 ± 4.96^{c} | 80.83 ± 3.39^{b} | 91.64 ± 5.22^{a} | 97.50 ± 0.69^{a} |
| G′ | 7.74 ± 0.34^{b} | 334.89 ± 46.45^{b} | 485.46 ± 137.16^{ab} | 1161.57 ± 335.92^{a} |
| G″ | 7.12 ± 0.18^{b} | 89.60 ± 7.32^{b} | 176.14 ± 55.30^{ab} | 361.51 ± 87.25^{a} |

Overall, the mayonnaises made from G-PPI exhibited better emulsion capacity and stability than those made from the same amount of PPI or egg yolk. With 8% of G-PPI, the mayonnaise emulsion had great emulsion capacity and stability (98%). As for the egg yolk mayonnaise, the egg concentration was needed to increase to 10% to reach similar emulsifying properties comparable with the 8% G-PPI mayonnaise, demonstrating the promising emulsifying application of the modified pea protein. Therefore, the G-PPI protein could be used as an alternative protein in dressings or alternative dairy applications to deliver the needed textural properties of such products. Others have prepared reduced-fat mayonnaise by partially replacing egg yolk with hydrolyzed faba bean proteins. Their results indicated that mayonnaise formulations containing 50% or 67% replacement of egg yolk powder with the faba bean protein had comparable properties with the conventional formulation. Chia mucilage is a soluble fiber extracted from chia seed and possesses great emulsifying and water-holding properties. Some have reported that partial substitution of oil and egg yolk with chia mucilage could result in mayonnaise with reduced fat content while acceptable sensory properties. Thus, alternative ingredients with desirable functional properties, particularly emulsification properties, could be used to (partially) replace egg yolk for mayonnaise dressing production.

### Rheological Properties

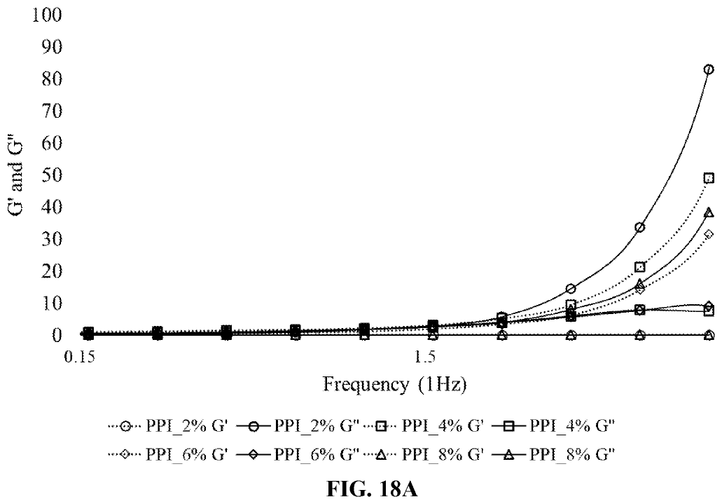

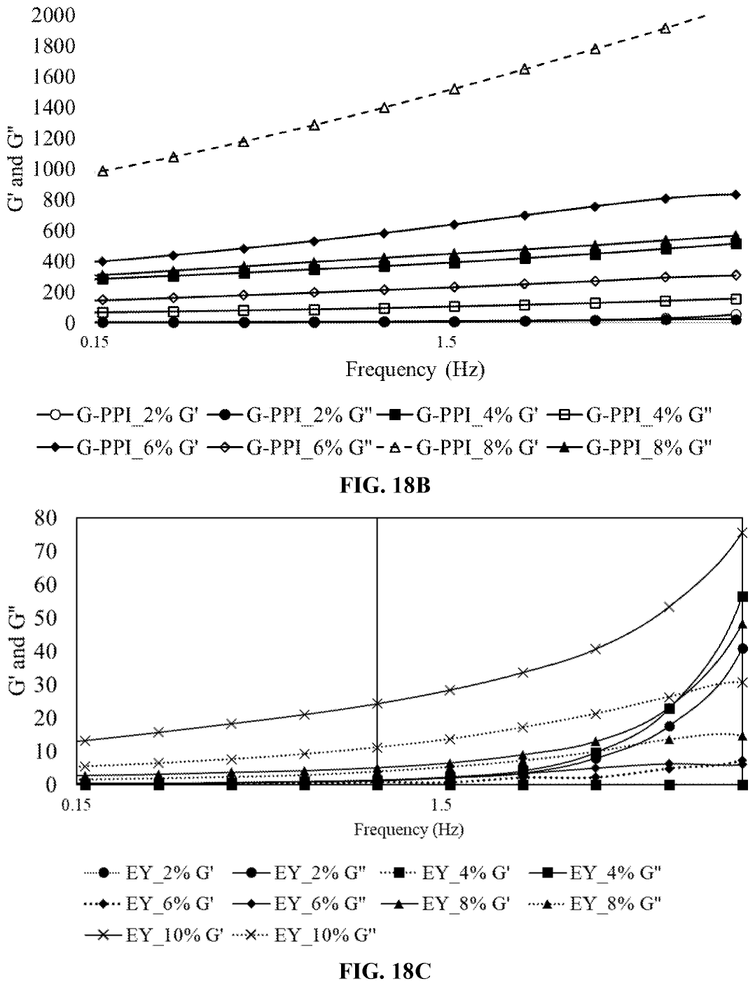

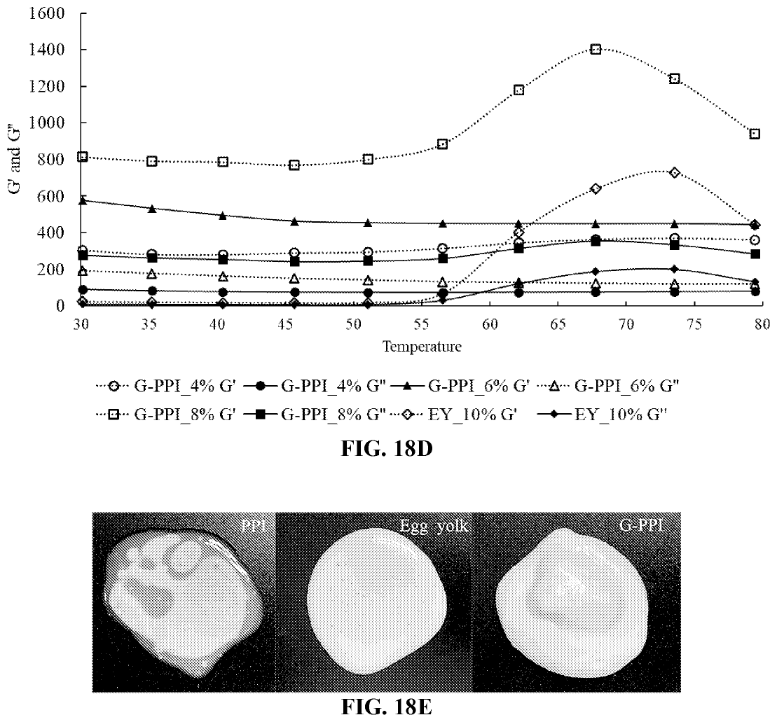

The rheological properties (G′ and G″), from both frequency and temperature sweeps of the mayonnaise samples, are shown in FIG. 18. The values of elastic modulus (G′) and viscous modulus (G″) from frequency sweep at 1 Hz are summarized in Table 17. The G-PPI mayonnaise showed significantly higher G′ and G″ values at 4, 6, and 8% additions than the other mayonnaises at the same protein or egg yolk concentration. The higher values of G′ than G″ for the G-PPI mayonnaises indicated that the mayonnaise had a solid-like behavior. On the other side, the PPI and egg yolk mayonnaises showed much lower G′ and G″ values with liquid-like texture, which was attributed to their poorer emulsifying properties. The rheological properties of promising mayonnaise formulations, such as those containing 4-8% G-PPI or 10% egg yolk, were further investigated through temperature scans (FIG. 18). When the temperature was increased from 30 to 80° C., the G′ value remained higher than the G″ for the same sample, the modulus values remained similar or higher than that at room temperature, implying that the mayonnaise samples were thermal stable and maintained the solid-like texture during heating. The mayonnaise samples with 8% G-PPI or 10% egg yolk showed G′ peak at 67 and 73° C., respectively. This was probably because the proteins in the mayonnaise were greatly unfolded and denatured around this temperature. The protein molecules aggregated and formed rigid gel networks with a spatial structure at higher protein concentrations, resulting in an increase of G′ and G″ (Xiao et al., 2020).

### Microstructures

Microstructure of the emulsion and mayonnaise droplets is shown in FIG. 20. The G-PPI emulsion (1.5% protein) contained abundant emulsion droplets with more compact and uniform structures. In comparison, the PPI emulsion (1.5% protein) had much fewer droplets at the same amount of protein emulsifier. This was attributed to the improved emulsifying properties of the G-PPI protein. The protein and guar gum conjugation enhanced the balance of protein hydrophobicity and hydrophilicity and prevented droplets from flocculation or coalescence by increasing steric repulsion. Mayonnaise samples with a higher concentration of G-PPI (6 and 8%) and egg yolk (10%) showed more uniform microstructures. In comparison, the PPI or egg yolk mayonnaise at lower protein concentration showed oil droplets with flocculation. This phenomenon was consistent with the result of emulsifying properties and droplet size measurements. Some have reported that mayonnaise made with an equal composition of egg yolk and faba bean protein exhibited finer average particle size and higher monodispersity levels compared with egg yolk or faba bean protein alone. This was because the faba bean protein promoted the emulsifying properties and surface functionality besides the egg yolk phospholipids and proteins; thus, the surface tension was reduced, allowing forming flexible protein film around the dispersed oil droplets to prevent flocculation and coalescence.

### Conclusions

The modification of pea protein through conjugating with guar gum improved its water and oil holding capacities, solubility, and gelation properties. This modified pea protein (G-PPI) demonstrated excellent emulsifying properties in different emulsion compositions and for mayonnaise application. The emulsions with G-PPI had significantly increased stability, apparent viscosity, and decreased droplet size compared with the PPI emulsions. The pH, salt concentration, protein emulsifier concentration, and oil/water ratio affected the emulsifying properties. The mayonnaises prepared with G-PPI at higher concentrations (6 and 8%) exhibited significantly better emulsification properties and viscoelasticity than PPI or egg yolk powder. This novel and “greenly” modified pea protein may be used as a healthier emulsifier in different food emulsions. This study will benefit researchers and food professionals interested in developing and utilizing plant proteins in various food applications.

1. A method of preparing a functional food ingredient comprising a plant protein, said method comprising:
providing a mixture or slurry of plant protein in an aqueous solution;
reacting said plant protein with a modification agent selected from the group consisting of an acylating agent, transglutaminase, and protein glutaminase to yield a modified plant protein; and
conjugating or physically intermixing said modified plant protein with a hydrophilic polysaccharide to yield said functional food ingredient.

2. The method of claim 1, wherein said acylating agent is acetic anhydride (AA) or succinic anhydride (SA).

3. The method of claim 1, wherein said hydrophilic polysaccharide is selected from the group consisting of guar gum, pectin, gum arabic, soybean soluble polysaccharide, xanthan, sodium alginate, propylene glycol alginate, carrageenan, chitosan, tara gum, carboxymethylcellulose, methylcellulose, hydroxypropylmethylcellulose, gellan gum, locust bean gum, and tragacanth gum.

4. The method of claim 1, wherein said plant protein is a protein meal, concentrate, isolate, or hydrolysate.

5. The method of claim 1, wherein said plant protein is selected from the group consisting of starchy legumes, starchy cereals, starchy pseudocereals, and oilseeds.

6. The method of claim 1, wherein said plant protein is selected from the group consisting of pea, soy, chickpea, lentil, lupin, wheat, maize, oats, rye, barley, triticale, rice, sorghum, buckwheat, quinoa, amaranth, chia, fababeans, navy beans, pinto beans, mung bean, sunflower seed, rapeseed, hempseed, and peanuts.

7. The method of claim 1, wherein said reacting step comprises mixing said plant protein with said modification agent for a time period of about 1 hour to about 24 hours at a temperature of about 20 to about 70° C. and a pH of about 5 to about 10.

8. The method of claim 1, wherein said conjugating step comprises mixing said modified plant protein with said hydrophilic polysaccharide for a time period of about 1 hour to about 24 hours at a temperature of about 20 to about 70° C. and a pH of about 5 to about 10.

9. The method of claim 1, further comprising collecting said functional food ingredient via filtration and/or centrifugation and drying said collected functional food ingredient.

10. The method of claim 1, wherein said modified plant protein is an acylated plant protein, crosslinked plant protein, or deamidated plant protein.

11. A functional food ingredient comprising a plant protein having enhanced properties, said functional food ingredient comprising an acylated plant protein, crosslinked plant protein, or deamidated plant protein conjugated or intermixed with a hydrophilic polysaccharide.

12. The functional food ingredient of claim 11, wherein said hydrophilic polysaccharide is selected from the group consisting of guar gum, pectin, gum arabic, soybean soluble polysaccharide, xanthan, sodium alginate, propylene glycol alginate, carrageenan, chitosan, tara gum, carboxymethylcellulose, methylcellulose, hydroxypropylmethylcellulose, gellan gum, locust bean gum, tragacanth gum.

13. The functional food ingredient of claim 11, wherein said plant protein is selected from the group consisting of starchy legumes, starchy cereals, starchy pseudocereals, and oilseeds.

14. The functional food ingredient of claim 11, wherein said plant protein is selected from the group consisting of pea, soy, chickpea, lentil, lupin, wheat, maize, oats, rye, barley, triticale, rice, sorghum, buckwheat, quinoa, amaranth, chia, fababeans, navy beans, pinto beans, mung bean, sunflower seed, rapeseed, hempseed, and peanuts.

15. The functional food ingredient of claim 11, wherein said functional food ingredient has a solubility in water of greater than about 40%.

16. The functional food ingredient of claim 11, wherein said functional food ingredient has an increased oil-holding-capacity as compared to an unmodified control protein, wherein said oil-holding-capacity is increased by at least about 40%.

17. The functional food ingredient of claim 11, wherein said functional food ingredient has an increased emulsion stability as compared to an unmodified control protein, wherein said emulsion stability is increased by at least about 40%.

18. A food comprising a functional food ingredient according to claim 11.

19. The food of claim 17, wherein said functional food ingredient is a binder, extender, or emulsifier in said food.

20. The food of claim 17, wherein the food is selected from the group consisting of ground or minced meat, emulsified meat, meat analog, mayonnaise, gravy, yogurt, meal replacement beverage, soft drink, dairy analog, dairy alternative, butter, margarine, creamer, salad dressing, soup, sauce, dessert, and ice cream.
